(19) United States
(12) Patent Application Publication
(10) Pub. No.: US 2026/0209105 A1
(43) Pub. Date: Jul. 23, 2026

(54) TRANSPARENT COLORLESS SPINEL MICROCRYSTALLINE GLASS, AND PREPARATION AND USE THEREOF

(71) Applicant: CHONGQING AUREAVIA HI-TECH GLASS CO., LTD., Chongqing (CN)

(72) Inventors: Hao HUANG, Chongqing (CN); Jingpeng ZHOU, Chongqing (CN); Qian TIAN, Chongqing (CN); Xiaolan XIE, Chongqing (CN); Wenhao XIANG, Chongqing (CN)

(21) Appl. No.: 19/132,849

(22) PCT Filed: Jun. 9, 2023
(86) PCT No.: PCT/CN2023/099315

§ 371 Date: May 26, 2025

(30) Foreign Application Priority Data
Dec. 2, 2022 (CN) 202211546703.5

(51) Int. Cl. C03C 3/085; C03C 3/093; C03C 3/095; C03C 21/00

(52) U.S. Cl. CPC C03C 3/085; C03C 3/093; C03C 3/095; C03C 21/001

(57) ABSTRACT

Provided are transparent colorless spinel microcrystalline glass, and preparation and use thereof. The microcrystalline glass contains (Zn, Mg) Al₂O₄ as a principal crystalline phase and ZrO₂ as a secondary tetragonal crystalline phase, and does not contain TiO₂. In mole percentage on an oxide basis, an oxide contained therein satisfies the following relational expressions: Al₂O₃/(MgO+ZnO)=1.40~2.00, and K₂O+Li₂O+Na₂O+B₂O₃)/(SiO₂+Al₂O₃)=0.10~0.20. The microcrystalline glass is obtained by performing heat treatment at a temperature of being not greater than 800° C. The microcrystalline glass has a transmittance of 85.0% or above for light having a wavelength of 550 nm. Anti-abrasive paper drop testing is performed on the microcrystalline glass by using 80-mesh abrasive paper, the average anti-abrasive paper drop height of the microcrystalline glass is greater than or equal to 1.00 m; the Vickers hardness is 800 kgf/mm² or above, and the fracture toughness of the microcrystalline glass is 1.200 MPa·m^{1/2} or above.

### CROSS-REFERENCE TO RELATED APPLICATION

The present disclosure claims the priority of the Chinese application with application No. CN202211546703.5 submitted to China National Intellectual Property Administration on Dec. 2, 2022, and the contents of which are incorporated herein by reference in entirety.

### TECHNICAL FIELD

The present disclosure relates to transparent microcrystalline glass, and more specifically, to a transparent colorless microcrystalline glass with zinc-magnesium spinel solid solution as the principal crystalline phase.

### BACKGROUND ART

With the development and progress of material science, many new materials have been used in the design and manufacture of intelligent terminal equipment. Microcrystalline glass materials have become a better choice for screen covers because of their excellent mechanical properties and excellent photopermeability. Microcrystalline glass, also known as glass-ceramics, is a material in which specific crystals are precipitated inside the glass by heat treatment for the base glass. The crystals dispersed inside the microcrystalline glass make it possible to have the physical property value that cannot be obtained in ordinary glass, for example, the significant enhancement of mechanical strength such as Young's modulus and shear toughness, and significant improvement in resistance to acidic and alkaline liquids.

Zinc-spinel (ZnAl₂O₄) is a cubic mineral. According to Mohs hardness scale, the hardness of the spinel is 7.5~8, and the measured density is 4.38~4.60 g/cm³. At ambient pressure, the Young's modulus of the zinc-spinel is about 290 GPa, the shear modulus is about 146 GPa, and the refractive index is 1.79~1.80. However, zinc-spinel crystals can easily make the glass opaque, and it is difficult to prepare transparent microcrystalline glass, which is not suitable for the preparation of screen cover. Although transparent microcrystalline glass can be prepared with magnesium-spinel (MgAl₂O₄) as the principal crystalline phase, the Young's modulus and shear modulus of magnesium-spinel crystal are not as good as those of zinc-spinel. Zinc-magnesium-spinel solid solution (Zn, Mg) Al₂O₄ is formed from zinc-spinel and magnesium-spinel, wherein the properties of the solid solution are almost the same as those of zinc-spinel (ZnAl₂O₄), and transparent microcrystalline glass can be prepared by taking the zinc-magnesium-spinel solid solution as the principal crystalline phase. Compared with transparent microcrystalline glass with magnesium-spinel as the principal crystalline phase, the transparent spinel microcrystalline glass with zinc-magnesium-spinel solid solution as the principal crystalline phase has higher Young's modulus and shear modulus, which can bring higher mechanical strength to microcrystalline glass materials.

U.S. Pat. No. 5,968,857A discloses a kind of microcrystalline glass with spinel as the main crystalline phase, which is composed of, expressed as a percentage by weight based on the oxide: 45~65% SiO₂, 14~28% Al₂O₃, 4~13% ZnO, 0~8% MgO, 0~10% TiO₂, 0~6% ZrO₂, 0~8% BaO, and 0~15% CsO, in which the combination of ZnO+MgO is greater than or equal to about 8, and the combination of TiO₂+ZrO₂ is greater than about 4, and the obtained microcrystalline glass has an optical property with a visible light transmittance of 85%. In a single-stage (or two-stage) heat treatment process, the upper temperature limit for crystal growth is preferably maintained within the range of 875~1050° C.

Patent application CN104478219A discloses a kind of spinel microcrystalline glass with 56~62 wt % SiO₂, 19~23 wt % Al₂O₃, 6~15 wt % ZnO, 2~6.5 wt % MgO, 2~6 wt % TiO₂, 2~7 wt % ZrO₂ as the basic composition, the crystallization treatment temperature of 880° C.~1050° C., and the average grain size of 30~100 nm.

Patent application CN111018354A discloses a kind of microcrystalline glass with low melting temperature, which composed of SiO₂: 48~55 mol %, Al₂O₃: 14~17 mol %, ZnO: 2~12 mol %, MgO: 8~16 mol %, TiO₂: 0.5~4.5 mol %, ZrO₂: 0.1-3 mol %, Sb₂O₃: 0.5~1 mol % and Na₂O: 2~12 mol %, in which a two-step heat treatment is carried out at 650~750° C. and 800~870° C. to obtain a kind of spinel microcrystalline glass with a visible light transmittance not less than 80%.

### SUMMARY

The inventors studied and found that the spinel microcrystalline glass disclosed in the prior art generally cannot be toughened by chemical strengthening, resulting in that although the spinel microcrystalline glass has the characteristics of high hardness, the toughness is poor, and the drop resistance is poor, especially when the thickness is relatively small (≤1 mm), the brittleness is more obvious, so that it is not suitable for manufacturing the electronic cover glass requiring high impact resistance.

For the electronic cover glass, it is necessary to have excellent deep stress characteristics, such as a relatively high DOL_0 and CT_AV, especially the relatively high DOL_0, so as to achieve good drop resistance. In order to achieve excellent deep stress characteristics, the common means adopted in this field is to chemically strengthen the base glass to obtain the relatively high DOL_0 and CT_AV through ion exchange. In order to meet the requirements of ion-exchange chemical strengthening, it is necessary to add a certain amount of alkali metal oxides, such as Li₂O and Na₂O, to the glass composition.

However, after further research, the inventors found that with the increase of the addition amount of Li₂O and Na₂O in the composition of spinel microcrystalline glass, zinc-magnesium-spinel solid solution is precipitated in the glass, but at the same time, some crystals that affect the optical properties of the microcrystalline glass are precipitated, such as β-quartz (SiO₂), β-quartz solid solution (MgAl₂Si₃O₁₀), β-spodumene. The precipitation of these impurity phase crystals easily leads to fogging or even devitrification of the prepared microcrystalline glass, so that it is difficult to obtain ideal transparent colorless spinel microcrystalline glass. How to make spinel microcrystalline glass meet the requirements of stress characteristics of cover glass while maintaining excellent optical properties is a technical problem that the inventors need to solve urgently.

Moreover, the inventors further found that the upper temperature limit for heat treatment in the preparation of spinel microcrystalline glass in the prior art, such as crystallization temperature in two-step heat treatment, is generally higher than 800° C., mostly above 850° C., or even above 900° C. However, such a high heat treatment temperature requires a relatively high demand on the heat treatment kiln, which is not conducive to energy saving and carbon reduction, thus greatly limiting the mass production of spinel microcrystalline glass.

In addition, most of the existing disclosed zinc-magnesium spinel transparent microcrystalline glass adopts a composite nucleating agent (TiO₂+ZrO₂) to promote the molding of zinc-magnesium spinel microcrystalline glass. When TiO₂ is adopted as the nucleating agent, it is very easy to cause the glass to be colored; when only ZrO₂ is adopted as the nucleating agent, it is very easy to form ZrO₂ sediment, resulting in the glass being locally whitened, so that the overall uniformity of the glass is deteriorated.

In response to the problems found in the above research and development process, the inventor, through a large number of experimental research and analyses, found that: when adjusting the content of oxides in the glass formula, such as the content of Al₂O₃, Li₂O, Na₂O, B₂O₃, and ZrO₂, a kind of colorless and transparent spinel microcrystalline glass with a high degree of transparency and with a heat treatment temperature lower than 800° C. can be obtained. The mass producibility of the colorless transparent spinel microcrystalline glass has been greatly improved. The microcrystalline glass can be chemically strengthened to produce chemically strengthened microcrystalline glass with excellent deep stress characteristics.

Specifically, the following technical solutions are provided in the present disclosure.
1. A microcrystalline glass is characterized in that it contains a zinc-magnesium-spinel solid solution (Zn, Mg) Al₂O₄ as a principal crystalline phase and a tetragonal ZrO₂ (tetragonal zirconia) as a secondary crystalline phase. The microcrystalline glass contains the following proportions of oxide components in terms of molar percentage of oxides:

| component | mol % |
|---|---|
| SiO₂ | 38.00%~50.00% |
| Al₂O₃ | 25.00%~30.00% |
| MgO | 4.00%~8.00% |
| ZnO | 8.00%~14.00% |
| ZrO₂ | 3.00%~5.00% |
| Li₂O | 3.00%~8.00% |
| | (Excluding 8.00 mol %) |

Furthermore, the microcrystalline glass is basically free of TiO₂, wherein “basically free” means that TiO₂ is not actively added or dosed into the glass, but can be present in very small amounts as an impurity or contaminant, wherein
the content of the oxide component of the microcrystalline glass satisfies the following relational expressions:

$${Al}_{2} {O}_{3} / ( MgO + Z n O ) = 1.4 ∼ 2. ; \qquad ( 1 )$$

$$( {K}_{2} O + L {i}_{2} O + N {a}_{2} O + {B}_{2} {O}_{3} ) / ( Si {O}_{2} + {Al}_{2} {O}_{3} ) = 0.1 ∼ 0.2 . \qquad ( 2 )$$

In the above relational expressions, each oxide represents the mole percentage content of oxide in the component.
2. The microcrystalline glass according to the technical solution 1, wherein the mole percentage of SiO₂ in the microcrystalline glass is 38.50%~48.50%; and/or the mole percentage of Al₂O₃ is 25.00%~29.00%; and/or the mole percentage of MgO is 4.50%~7.50%; and/or the mole percentage of ZnO is 8.50%~13.50%; and/or the mole percentage of ZrO₂ is 3.50%~4.50%; and/or the mole percentage of Li₂O is 3.00%~7.80%.
3. The microcrystalline glass according to the technical solution 1 or 2, wherein the microcrystalline glass is prepared by adopting ZrO₂ as a nucleating agent.
4. The microcrystalline glass according to any one of the technical solutions 1-3, wherein the microcrystalline glass further contains oxide components in the following proportions in terms of mole percentage of oxides:

| | |
|---|---|
| Na₂O | 0%~6.00% |
| K₂O | 0%~3.00% |
| B₂O₃ | 0%~6.00% |
| BaO | 0%~4.00% |
| Y₂O₃ | 0%~2.00% |
| La₂O₃ | 0%~2.00% |

5. The microcrystalline glass according to any one of the technical solutions 1-4, wherein the content of oxide components, in terms of mol %, satisfies at least one of the relational expressions (3), (4) and (5):

$${Al}_{2} {O}_{3} / Si {O}_{2} = 0.5 ∼ 0.8 ; \qquad ( 3 )$$

$$L {i}_{2} O / ( {K}_{2} O + L {i}_{2} O + N {a}_{2} O ) = 0 \text{.25} ∼ 0.85 ; \qquad ( 4 )$$

$$L {i}_{2} O + N {a}_{2} O \geq 7. mol \% . \qquad ( 5 )$$

6. The microcrystalline glass according to any one of the technical solutions 1-5, wherein the microcrystalline glass is obtained by heat treatment at a temperature not exceeding 800° C.
7. The microcrystalline glass according to any one of the technical solutions 1-6, wherein the weight ratio of the crystal phase of the microcrystalline glass to the microcrystalline glass is 25.0~45.0 wt %, preferably 30.0~45.0 wt %, and more preferably 32.0~40.0 wt %.
8. The microcrystalline glass according to any one of the technical solutions 1-7, wherein the average grain size of the microcrystalline glass is 3.0~30.0 nm, preferably 3.0~10.0 nm, more preferably 5.0~6.5 nm, and further preferably 5.2~6.5 nm.
9. The microcrystalline glass according to any one of the technical solutions 1-8, wherein the Young's modulus of the microcrystalline glass is ≥110 GPa; preferably, 130 GPa≥Young's modulus ≥110 GPa; and more preferably, 130 GPa≥Young's modulus ≥114 GPa.
10. The microcrystalline glass according to any one of the technical solutions 1-9, wherein when the thickness is 0.7 mm, the microcrystalline glass has the following transmission color coordinates in the CIELAB color space:
a*=−0.15~0.15, preferably −0.15 to −0.03; and
b*=0.30~0.90, preferably 0.60 to 0.85; which is for D65 light source in SCI mode.
11. The microcrystalline glass according to any one of the technical solutions 1-10, wherein when the thickness is 0.7 mm and under the light with a wavelength of 550 nm, the microcrystalline glass has a transmittance above 85.0%, preferably the transmittance is 88.0%~95.0%; when the thickness is 0.7 mm and under the light with a wavelength of 360 nm, the transmittance of the microcrystalline glass is above 70.0%.
12. The microcrystalline glass according to any one of the technical solutions 1-11, wherein the microcrystalline glass contains a compressive stress layer formed by ion exchange.
13. The microcrystalline glass according to the technical solution 12, wherein the microcrystalline glass includes a compressive stress layer, wherein the depth of the compressive stress layer is DOL_0≥0.14t, where t is the thickness of the microcrystalline glass, preferably 0.20t≥DOL_0≥0.15t.
14. The microcrystalline glass according to the technical solution 12 or 13, wherein the microcrystalline glass has a |CT_AV| of ≥40.0 MPa, preferably 80.0 MPa≥|CT_AV|≥40.0 MPa.
15. The microcrystalline glass according to any one of the technical solutions 12-14, wherein the microcrystalline glass is obtained by chemical strengthening treatment in a salt bath containing potassium salt and/or sodium salt, wherein the salt bath contains 0~1 wt % lithium salt; preferably, the microcrystalline glass is obtained by chemical strengthening treatment in a mixed salt bath of sodium salt and potassium salt or a pure sodium salt bath; and further preferably, the microcrystalline glass is obtained by chemical strengthening treatment in a mixed salt bath of sodium nitrate and potassium nitrate or a sodium nitrate salt bath.
16. The microcrystalline glass according to the technical solution 15, wherein the concentration of sodium nitrate is 30~70 wt % in the mixed salt bath of sodium nitrate and potassium nitrate.
17. The microcrystalline glass according to any one of the technical solutions 12-16, wherein the Vickers hardness of the microcrystalline glass is above 750 kgf/mm², and/or
the fracture toughness of the microcrystalline glass is above 1.200 MPa·m^{1/2}, preferably above 1.400 MPa·m^{1/2}, and more preferably above 1.500 MPa·m^{1/2}.
18. The microcrystalline glass according to any one of the technical solutions 12-17, wherein at a thickness of 0.7 mm, the microcrystalline glass is performed on anti-abrasive-paper drop testing by using 80-mesh abrasive paper, and the average anti-abrasive-paper drop height of the microcrystalline glass is greater than or equal to 0.80 m, preferably the average anti-abrasive-paper drop height is 1.00~1.60 m.
19. The preparation method of the microcrystalline glass according to any one of the technical solutions 1-11 is characterized by including the following steps:
(1) preparation of base glass: based on the mole percentage of oxides, the base glass contains the following proportions of oxide components: SiO₂: 38.00%~50.00%, Al₂O₃: 25.00%~30.00%,
MgO: 4.00%~8.00%, ZnO: 8.00%~14.00%, ZrO₂: 3.00%~5.00%,
Li₂O: 3.00%~8.00% (excluding 8.00 mol %);
and the base glass does not contain TiO₂; and
the content of the oxide components of the base glass satisfies the following relational expressions:

$${Al}_{2} {O}_{3} / ( MgO + Z n O ) = 1.4 ∼ 2. ;$$

$$( {K}_{2} O + L {i}_{2} O + N {a}_{2} O + {B}_{2} {O}_{3} ) / ( Si {O}_{2} + {Al}_{2} {O}_{3} ) = 0.1 ∼ 0.2 ;$$

(2) preparation of microcrystalline glass: the base glass obtained in step (1) is subjected to heat treatment to obtain the microcrystalline glass according to any one of the technical solutions 1-11.
20. The preparation method according to the technical solution 19, wherein in step (2), the heat treatment includes a nucleation treatment and a crystallization treatment carried out sequentially, wherein the temperature of the nucleation treatment is 650° C.~850° C., preferably 650° C.~750° C., and the duration of the nucleation treatment is 0 h~72 h, preferably 0 h~24 h; the temperature of the crystallization treatment is 700° C.~1000° C., preferably 700° C.~800° C., and the duration of the crystallization treatment is 0.1 h~72 h, preferably 0.1 h~24 h.
21. The preparation method according to the technical solution 19 or 20, wherein in terms of the mole percentage of oxides, the base glass further contains oxide components in the following proportions: Na₂O: 0%~6.00%, K₂O: 0%~3.00%, B₂O₃: 0%~6.00%, BaO: 0%~4.00%, Y₂O₃: 0%~2.00%, and La₂O₃: 0%~2.00%; and/or the content of oxide components, in terms of mol %, satisfies at least one of the following relational expressions: Al₂O₃/SiO₂=0.50~0.80; Li₂O/(K₂O+Li₂O+Na₂O)=0.25~0.85; Li₂O+Na₂O≥7.00 mol %.
22. The preparation method according to any one of the technical solutions 19-21, wherein the method further includes the following step:
performing chemical strengthening treatment on the microcrystalline glass obtained by heat treatment, so as to obtain the microcrystalline glass according to any one of the technical solutions 12-18.
23. A microcrystalline glass obtained by the preparation method according to any one of the technical solutions 19-22.
24. Use of the microcrystalline glass according to any one of the technical solutions 1-18 or the microcrystalline glass according to the technical solution 23 in a mobile phone display screen, a tablet computer display screen, a handheld game console, an electronic terminal, a portable digital device, a vehicle-mounted central control screen, an electronic whiteboard glass, a smart home touch screen, a vehicle windshield glass, an aerocraft windshield glass or an aircraft windshield glass.
25. A base glass, wherein the base glass can be configured to prepare the microcrystalline glass according to any one of the technical solutions 1-18, in terms of the mole percentage of oxides, the base glass contains oxide components in the following proportions: SiO₂: 38.00%~50.00%, Al₂O₃: 25.00%~30.00%, MgO: 4.00%~8.00%, ZnO: 8.00%~14.00%, ZrO₂: 3.00%~5.00%, Li₂O: 3.00%~8.00% (excluding 8.00 mol %); and the base glass does not contain TiO₂, wherein the content of the oxide components of the base glass satisfies the following relational expressions: Al₂O₃/(MgO+ZnO)=1.40~2.00; (K₂O+Li₂O+Na₂O+B₂O₃)/(SiO₂+Al₂O₃)=0.10~0.20.
26. The base glass according to the technical solution 25, wherein in terms of the mole percentage of oxides, the base glass further contains oxide components in the following proportions: Na₂O: 0%~6.00%, K₂O: 0%~3.00%, B₂O₃: 0%~6.00%, BaO: 0%~4.00%, Y₂O₃: 0%~2.00%, and La₂O₃: 0%~2.00%; and/or the content of oxide components, in terms of mol %, satisfies at least one of the following relational expressions: Al₂O₃/SiO₂-0.50~0.80; Li₂O/(K₂O+Li₂O+Na₂O)=0.25~0.85; Li₂O+Na₂O≥7.00 mol %.

In the present disclosure, the molding methods for the base glass include but are not limited to floating, overflowing, calendering or casting processes. Exemplarily, the base glass is obtained by mixing evenly the components according to the formula, melt molding, and then cooling and annealing. When preparing the base glass, a clarifying agent can be added to the base glass, wherein the clarifying agent includes but is not limited to SnO₂, Sb₂O₃ and NaCl. Based on the mass of the base glass, the amount of the added clarifying agent is from 0.01 wt % to 2.00 wt %, and preferably from 0.01 wt % to 1.50 wt %.

The technical solution of the present disclosure has the following beneficial effects: according to the transparent colorless spinel microcrystalline glass of the present disclosure, the contents of oxides such as Al₂O₃, Li₂O, Na₂O, B₂O₃, ZrO₂ are matched reasonably, and the contents of individual oxides meet the requirements of a specific relationship, so that in the case of adopting ZrO₂ as a nucleating agent and basically not adopting TiO₂ as a nucleating agent, the target microcrystalline glass with specific structure, good overall uniformity and high intrinsic strength can be obtained with a relatively low heat treatment temperature. According to the optimized spinel microcrystalline glass formulation of the present disclosure, the heat treatment temperature required for preparing the target microcrystalline glass can be significantly reduced, so as to meet the development requirements of energy saving and carbon reduction in the industry, such that the mass producibility of transparent colorless spinel microcrystalline glass is improved, and the excellent optical properties of the microcrystalline glass are ensured; and meanwhile, the microcrystalline glass has high Young's modulus and hardness, and chemically strengthened microcrystalline glass with excellent drop resistance can be obtained by performing chemical strengthening on the microcrystalline glass.

### BRIEF DESCRIPTION OF THE DRAWINGS

FIG. 1 is a DSC test graph of base glass D3.

FIG. 2 is a DSC test graph of base glass D4.

FIG. 3 is a DSC test graph of base glass S3.

FIG. 4 is a DSC test graph of base glass S5.

FIG. 5 is a brick-forming picture of base glass D1.

FIG. 6 is a picture of a microcrystalline glass sample corresponding to Experiment No. 3.

FIG. 7 is an XRD test graph of a microcrystalline glass corresponding to Experiment No. 19.

FIG. 8 is a picture of a microcrystalline glass sample corresponding to Experiment No. 18.

### DETAILED DESCRIPTION OF EMBODIMENTS

In the present disclosure, in view of the difficulty of mass production of transparent spinel microcrystalline glass, and the technical problems of the microcrystalline glass in the direction of both excellent transparency and excellent mechanical properties (especially drop resistance) in the prior art, by adjusting the formulation composition of the microcrystalline glass, and exploring the specific process parameters, a transparent colorless spinel microcrystalline glass is provided with the heat treatment temperature below 800° C., and the microcrystalline glass has excellent optical properties and can be chemically strengthened to obtain excellent deep stress characteristics.

In the first aspect, a microcrystalline glass is provided in the present disclosure, which satisfies the following items.
(1) The crystalline phase of the microcrystalline glass of the present disclosure includes zinc-magnesium-spinel solid solution (Zn, Mg) Al₂O₄ and tetragonal zirconia ZrO₂, wherein the principal crystalline phase is zinc-magnesium-spinel solid solution (Zn, Mg) Al₂O₄.
(2) Based on the mole percentage of oxides, the microcrystalline glass contains the following proportions of oxide components: SiO₂: 38.00%~50.00%, Al₂O₃: 25.00%~30.00%, MgO: 4.00%~8.00%, ZnO: 8.00%~14.00%, ZrO₂: 3.00%~5.00%, Li₂O: 3.00%~8.00% (excluding 8.00 mol %).

$${Al}_{2} {O}_{3} / ( MgO + Z n O ) = 1.4 ∼ 2. . \qquad ( 3 )$$

$$( {K}_{2} O + L {i}_{2} O + N {a}_{2} O + {B}_{2} {O}_{3} ) / ( Si {O}_{2} + {Al}_{2} {O}_{3} ) = 0.1 ∼ 0.2 . \qquad ( 4 )$$

$${Al}_{2} {O}_{3} / {SiO}_{2} = 0.5 ∼ 0.8 . \qquad ( 5 )$$

$${Li}_{2} O / ( {K}_{2} O + L {i}_{2} O + N {a}_{2} O ) = 0.25 ∼ 0.85 . \qquad ( 6 )$$

$${Li}_{2} O + N {a}_{2} O \geq 7. mol \% . \qquad ( 7 )$$

Note: In the relational expressions between (3) and (7), the mole percentage content of each oxide is brought into the relational expressions for calculation.
(8) The nucleating agent contains ZrO₂, which basically does not contain TiO₂, wherein “basically free” means that TiO₂ is not actively added or dosed into the glass, but can be present in very small amounts as an impurity or contaminant.
(9) When preparing the microcrystalline glass, the upper temperature limit for heat treatment can be lower than or equal to 800° C., that is, the microcrystalline glass can be obtained by heat treatment at a temperature no higher than 800° C.
(10) Based on the mole percentage of oxides, the base glass contains the following proportions of oxide components: Na₂O 0%~6.00%, K₂O: 0%~3.00%, B₂O₃: 0%~6.00%, BaO: 0%~4.00%, Y₂O₃: 0%~2.00%, and La₂O₃: 0%~2.00%.
(11) Young's modulus ≥110 GPa, preferably, 130 GPa≥Young's modulus ≥110 GPa, more preferably, 130 GPa≥Young's modulus ≥114 GPa.
(12) The average grain size is 3.0~30.0 nm, preferably 3.0~10.0 nm, more preferably 5.0~6.5 nm.
(13) The weight ratio of crystal phase to microcrystalline glass is 25.0~45.0 wt %, preferably 30.0~45.0 wt %, more preferably 32.0~40.0 wt %.
(14) When the thickness is 0.7 mm, the microcrystalline glass has the following transmission color coordinates in CIELAB color space: a*=−0.15 to 0.15, and b*=0.30 to 0.90; which is for D65 light source in SCI mode.
(15) When the thickness is 0.7 mm and under the light with a wavelength of 550 nm, the microcrystalline glass has a transmittance above 85.0%, preferably the transmittance is 88.0%~95.0%; when the thickness is 0.7 mm and under the light with a wavelength of 360 nm, the transmittance of the microcrystalline glass is above 70.0%.
(16) The microcrystalline glass contains a compressive stress layer formed by ion exchange, wherein the depth of the compressive stress layer DOL_0 is greater than or equal to 0.14t, and t is the thickness of the microcrystalline glass. For example, when t=0.7 mm, the depth of the compressive stress layer DOL_0 of the microcrystalline glass is greater than or equal to 98 μm, preferably 100~140 μm. The compressive stress layer extends from the surface of the microcrystalline glass to the depth of compression, and a tensile stress layer capable of achieving force balance with the compressive stress layer is formed inside the microcrystalline glass. It should be understood that after the ion exchange process, the composition at the surface of the microcrystalline glass (for example, the compressive stress layer) can be different from the composition of the newly formed microcrystalline glass (i.e., the microcrystalline glass before the ion exchange process). This is because during ion exchange, one type of alkali metal ions (for example, Li⁺ or Na⁺) in the newly formed microcrystalline glass is replaced by larger alkali metal ions (for example, Na⁺ or K⁺) respectively. However, in the embodiment, the composition of the microcrystalline glass at or near the depth-wise center of the glass product (for example, the tensile stress layer) will still retain the composition of the newly formed microcrystalline glass.
(17) When performing chemical strengthening on the microcrystalline glass, the chemical strengthening treatment can be carried out in a salt bath of potassium salt and/or sodium salt, wherein the salt bath can contain 0~1 wt % of lithium salt, preferably the chemical strengthening treatment can be carried out in a mixed salt bath of sodium salt and potassium salt or a pure sodium salt bath, and further preferably, the chemical strengthening treatment can be carried out in a mixed salt bath of sodium nitrate and potassium nitrate or a sodium nitrate salt bath, so as to obtain the microcrystalline glass with the absolute value of the average tensile stress |CT_AV|≥40.0 MPa, preferably 80.0 MPa≥|CT_AV|≥40.0 MPa. When the chemical strengthening treatment adopts a mixed salt bath of sodium nitrate and potassium nitrate, the concentration of sodium nitrate in the mixed salt bath is preferably 30~70 wt %.
(18) After chemical strengthening treatment, the Vickers hardness of the microcrystalline glass is above 750 kgf/mm², and/or the fracture toughness of the microcrystalline glass is above 1.200 MPa·m^{1/2}, preferably above 1.400 MPa·m^{1/2}, and more preferably above 1.50 MPa·m^{1/2}.
(19) At the thickness of 0.7 mm, the microcrystalline glass containing a compressive stress layer was performed on anti-abrasive-paper drop testing by using 80-mesh abrasive paper, and the average anti-abrasive-paper drop height of the microcrystalline glass is greater than or equal to 0.80 m, preferably the average anti-abrasive-paper drop height is 1.00~1.60 m.

According to the transparent colorless spinel microcrystalline glass of the present disclosure, the contents of oxides such as Al₂O₃, Li₂O, Na₂O, B₂O₃, ZrO₂ are matched reasonably, the items of Al₂O₃≥25.00 mol %, and Li₂O=3.00~8.00 mol % (excluding 8.00 mol %) are satisfied. ZrO₂ is adopted as a nucleating agent, and TiO₂ is basically not adopted as a nucleating agent, and the content of each oxide meets the specific relationship requirements, such as Al₂O₃/(MgO+ZnO)=1.40~2.00, (K₂O+Li₂O+Na₂O+B₂O₃)/(SiO₂+Al₂O₃)=0.10~0.20, so that the target microcrystalline glass with specific structure, good overall uniformity and high intrinsic strength can be obtained with a relatively low heat treatment temperature (for example, the upper temperature limit for heat treatment does not exceed 800° C.). According to the optimized spinel microcrystalline glass formulation of the present disclosure, the heat treatment temperature required for preparing the target microcrystalline glass can be significantly reduced, so as to meet the development requirements of energy saving and carbon reduction in the industry; the preparation of transparent zinc-magnesium-spinel microcrystalline glass at a heat treatment temperature lower than 800° C. is realized, so as to improve the mass producibility of transparent spinel microcrystalline glass, and ensure the excellent optical properties of the microcrystalline glass. At the same time, the microcrystalline glass of the present disclosure has high Young's modulus and hardness, and chemically strengthened microcrystalline glass with excellent drop resistance can be obtained by performing chemical strengthening on the microcrystalline glass.

The base glass of the microcrystalline glass of the present disclosure can be directly produced by adopting existing molding processes, including but not limited to floating method, calendering method, casting method and overflowing method.

### The Function of Oxides

Increasing the contents of Li₂O and Na₂O helps to obtain higher stress, especially the excellent deep stress characteristics, and at the same time helps to reduce the melting temperature and the temperature of crystal precipitation. However, the excessive addition will lead to the precipitation of other impurity phases during the heat treatment process, which will reduce the transmittance of the obtained microcrystalline glass. In the microcrystalline glass of the present disclosure, the content of Li₂O is 3.00~8.00 mol % (excluding 8.00 mol %), and the content of Na₂O is 0~6.00 mol %.

In some embodiments, the microcrystalline glass can contain Li₂O with the molar percentages of 3.00 mol %~7.90 mol %, 3.50 mol %~7.90 mol %, 4.00 mol %~7.90 mol %, 4.50 mol %~7.90 mol %, 5.00 mol %~7.90 mol %, 5.50 mol %~7.90 mol %, 6.00 mol %~7.90 mol %, 6.50 mol %~7.90 mol %, 7.00 mol %~7.90 mol %, 3.00 mol %~7.50 mol %, 3.00 mol %~7.00 mol %, 3.00 mol %~6.50 mol %, 3.00 mol %~6.00 mol %, 3.00 mol %~5.50 mol %, 3.00 mol %~5.00 mol %, 3.00 mol %~4.50 mol %, 3.00 mol %~4.00 mol %. In some embodiments, the microcrystalline glass can contain Li₂O with the molar percentage of 3.00 mol %, 3.50 mol %, 4.00 mol %, 4.50 mol %, 5.00 mol %, 5.50 mol %, 6.00 mol %, 6.50 mol %, 7.00 mol %, 7.50 mol %, or 7.90 mol %, or the molar percentage that is within the range of values including the endpoints of any two specific values described above. It should be understood that in a specific embodiment, any of the above ranges can be combined with any other range, as long as the glass with the required properties of the present disclosure can be obtained.

In some embodiments, the microcrystalline glass can contain Na₂O with a molar percentage of 0~6 mol %, and specifically, the molar percentage content of Na₂O can be 0.5 mol %~5.5 mol %, 0.5 mol %~5 mol %, 0.5 mol %~4.5 mol %, 0.5 mol %~4 mol %, 0.5 mol %~3.5 mol %, 0.5 mol %~3.0 mol %, 0.5 mol %~2.5 mol %, 0.5 mol %~2.0 mol %, 0.5 mol %~1.5 mol %, 0.5 mol %~1.0 mol %, etc., and the molar percentage content of Na₂O can further be mole percentage contents such as 0.5 mol %, 1.0 mol %, 1.5 mol %, 2.0 mol %, 2.5 mol %, 3.5 mol %, 4.0 mol %, 4.5 mol %, 5.0 mol %, 5.5 mol %, and 6.0 mol %, or a mole percentage content within a numerical range with any two specific values described above as endpoints. It should be understood that in a specific embodiment, any of the above ranges can be combined with any other range, as long as the glass with the required performance of the present disclosure can be obtained.

The addition of Al₂O₃ can promote the precipitation of spinel, inhibit the precipitation of quartz ss and other impurity phases, and at the same time, increase the ion exchange rate in the strengthening process. However, too much Al₂O₃ will lead to a sharp increase in the difficulty of glass melting, while the rate of crystallization is extremely fast, which will lead to the devitrification of the glass during the normal cooling process. In the microcrystalline glass of the present disclosure, the content of Al₂O₃ is 25.00 mol %~30.00 mol %. Specifically, the content of Al₂O₃ can be a molar percentage content such as 25.00 mol %, 25.50 mol %, 26.00 mol %, 26.50 mol %, 27.00 mol %, 27.50 mol %, 28.00 mol %, 28.50 mol %, 29.00 mol %, 29.50 mol %, and 30.00 mol %, or can be a molar percentage content within a range of values consisting of any two of the above specific values as endpoints such as 25.00 mol %~29.50 mol %, and 26.00 mol %~28.50 mol %. It should be understood that in a specific embodiment, any of the above ranges can be combined with any other range, as long as the glass with the required performance of the present disclosure can be obtained.

MgO and ZnO, as the main components of spinel, can promote the precipitation of spinel and reduce the difficulty of melting in a certain extent. However, the addition of excessive MgO and ZnO often leads to excessive growth of spinel grains, making the excessive size of the grain, so that it difficult to obtain microcrystalline glass with high transparency; and meanwhile, the ratio of MgO to ZnO largely determines whether the sample can be transparent. In the microcrystalline glass of the present disclosure, the content of MgO is 4.00 mol %~8.00 mol %, and the content of ZnO is 8.00 mol %~14.00 mol %. Specifically, the content of MgO can be a molar percentage content such as 4.00 mol %, 4.50 mol %, 5.00 mol %, 5.50 mol %, 6.00 mol %, 6.50 mol %, 7.00 mol %, 7.50 mol %, and 8.00 mol %, or can be a molar percentage content within a range of values consisting of any two of the above specific values as endpoints such as 4.00 mol %~7.50 mol %, 4.00 mol %~7.00 mol %, 4.00 mol %~6.50 mol %, 4.00 mol %~6.00 mol %, 4.00 mol %~5.50 mol %, 4.50 mol %~5.00 mol %, 5.00 mol %~7.50 mol %, 5.00 mol %~7.00 mol %, 5.00 mol %~6.50 mol %, 5.00 mol %~6.00 mol %, and 5.00 mol %~5.50 mol %. It should be understood that in a specific embodiment, any of the above ranges can be combined with any other range, as long as the glass with the required performance of the present disclosure can be obtained. Specifically, the content of ZnO can be a molar percentage content such as 8.00 mol %, 8.50 mol %, 9.00 mol %, 9.50 mol %, 10.00 mol %, 10.50 mol %, 11.00 mol %, 11.50 mol %, 12.00 mol %, 12.50 mol %, 13.00 mol %, 13.50 mol %, and 14.00 mol %, or can be the molar percentage content within a range of values consisting of any two of the above specific values as endpoints such as 8.00 mol %~13.50 mol %, 8.00 mol %~13.00 mol %, 8.00 mol %~12.50 mol %, 8.00 mol %~12.00 mol %, 8.00 mol %~11.50 mol %, 8.00 mol %~11.00 mol %, 8.00 mol %~10.50 mol %, 8.00 mol %~10.00 mol %, 8.00 mol %~9.50 mol %, 8.00 mol %~9.00 mol %, 8.00 mol %~8.50 mol %, 8.50 mol %~13.50 mol %, 8.50 mol %~13.00 mol %, 8.50 mol %~12.50 mol %, 8.50 mol %~12.00 mol %, 8.50 mol %~11.50 mol %, 8.50 mol %~11.00 mol %, 8.50 mol %~10.50 mol %, 8.50 mol %~10.00 mol %, 8.50 mol %~9.50 mol %, 8.50 mol %~9.00 mol %, 9.50 mol %~13.50 mol %, 9.50 mol %~13.00 mol %, 9.50 mol %~12.50 mol %, 9.50 mol %~12.00 mol %, 9.50 mol %~11.50 mol %, 9.50 mol %~11.00 mol %, 9.50 mol %~10.50 mol %, 9.50 mol %~10.00 mol %, 10.00 mol %~13.50 mol %, 10.00 mol %~13.00 mol %, 10.00 mol %~12.50 mol %, 10.00 mol %~12.00 mol %, 10.00 mol %~11.50 mol %, 10.50 mol %~13.50 mol %, 10.50 mol %~13.00 mol %, 10.50 mol %~12.50 mol %, 10.50 mol %~12.00 mol %, 10.50 mol %~11.50 mol %, 10.50 mol %~11.00 mol %, 11.00 mol %~13.50 mol %, 11.00 mol %~13.00 mol %, 11.00 mol %~12.50 mol %, 11.00 mol %~12.00 mol %, 11.00 mol %~11.50 mol %, 11.50 mol %~13.50 mol %, 11.50 mol %~13.00 mol %, 11.50 mol %~12.50 mol %, 11.50 mol %~12.00 mol %, 12.00 mol %~13.50 mol %, and 12.00 mol %~13.00 mol %, 12.00 mol %~12.50 mol %. It should be understood that in a specific embodiment, any of the above ranges can be combined with any other range, as long as the glass with the required performance of the present disclosure can be obtained.

ZrO₂ is an effective nucleating agent. When the base glass is performed on the heat treatment, ZrO₂ is precipitated firstly in the form of crystals, and the ZrO₂ crystals become the crystal nuclei for the growth of subsequent crystals. In a certain range of the composition of glass, the content of ZrO₂ will affect the formation of base glass, and the shape, type and size of crystals in microcrystalline glass. By adjusting the composition of the base glass, ZrO₂ can be preferentially precipitated, and then the spinel crystal grows at the same temperature. In the microcrystalline glass of the present disclosure, the content of ZrO₂ is 3.00 mol %~5.00 mol %. Specifically, the content of ZrO₂ can be a molar percentage content such as 3.00 mol %, 3.10 mol %, 3.20 mol %, 3.30 mol %, 3.40 mol %, 3.50 mol %, 3.60 mol %, 3.70 mol %, 3.80 mol %, 3.90 mol %, 4.00 mol %, 4.10 mol %, 4.20 mol %, 4.30 mol %, 4.40 mol %, 4.50 mol %, 4.60 mol %, 4.70 mol %, 4.80 mol %, 4.90 mol % and 5.00 mol %, or can be the molar percentage content within a range of values consisting of any two of the above specific values as endpoints such as 3.10 mol %~4.90 mol %, 3.20 mol %~3.80 mol %, 3.30 mol %~3.70 mol %, and 3.40 mol %~3.60 mol %. Proper addition of B₂O₃ can greatly reduce the melting difficulty of glass and promote the precipitation of spinel, but excessive addition of B₂O₃ will easily lead to opacification during heat treatment, and at the same time, it can lead to the precipitation of other impurity crystal phases, which will seriously affect the transparency of glass. In the microcrystalline glass of the present disclosure, the content of B₂O₃ is 0~6.00 mol %. Specifically, the content of B₂O₃ can be a molar percentage content within the range such as 0.5 mol %~5.5 mol %, 0.5 mol %~5 mol %, 0.5 mol %~4.5 mol %, 0.5 mol %~4 mol %, 0.5 mol %~3.5 mol %, 0.5 mol %~3 mol %, 0.5 mol %~2.5 mol %, 0.5 mol %~2 mol %, 0.5 mol %~1.5 mol %, and 0.5 mol %~1 mol %, or can be a molar percentage content such as 0.5 mol %, 1 mol %, 1.5 mol %, 2.0 mol %, 2.5 mol %, 3.5 mol %, 4 mol %, 4.5 mol %, 5.0 mol %, 5.5 mol %, and 6 mol %, or can be the molar percentage content within a range of values consisting of any two of the above specific values as endpoints. It should be understood that in a specific embodiment, any of the above ranges can be combined with any other range, as long as the glass with the required performance of the present disclosure can be obtained.

SiO₂ is an oxide that forms the network skeleton of a glass and is configured to stabilize the network structure of glass and microcrystalline glass. When the content of SiO₂ is too low, the thermal expansion coefficient of glass tends to increase and the thermal shock resistance decreases; when the content of SiO₂ is too high, the fusibility of glass becomes worse, or the viscosity of molten glass liquid increases, making it difficult to clarify the glass liquid, so that the glass molding becomes more difficult, and the time required for glass crystallization becomes longer, so as to decrease the productivity. In the microcrystalline glass of the present disclosure, the content of SiO₂ is 38.00 mol %~50.00 mol %. Specifically, the content of SiO₂ can be a molar percentage content such as 38.00 mol %, 38.50 mol %, 39.00 mol %, 39.50 mol %, 40.00 mol %, 40.50 mol %, 41.00 mol %, 41.50 mol %, 42.00 mol %, 42.50 mol %, 43.00 mol %, 43.50 mol %, 44.00 mol %, 44.50 mol %, 45.00 mol %, 45.50 mol %, 46.00 mol %, 46.50 mol %, 47.00 mol %, 47.50 mol %, 48.00 mol %, 48.50 mol %, 49.00 mol %, 49.50 mol %, and 50.00 mol %, or can be the molar percentage content within a range of values consisting of any two of the above specific values as endpoints such as 38.00 mol %~49.50 mol %, 39.00 mol %~49.00 mol %, 40.00 mol %~48.00 mol %, 41.00 mol %~47.00 mol %, 42.00 mol %~46.00 mol %, 43.00 mol %~45.00 mol %, 43.00 mol %~44.00 mol %, and 38.50 mol %~49.50 mol %. It should be understood that in a specific embodiment, any of the above ranges can be combined with any other range, as long as the glass with the required performance of the present disclosure can be obtained.

K₂O is an oxide outside the network. Because the radius of K⁺ is larger than that of Na⁺, adding K₂O in a proper amount can reduce the tendency of crystallization of the glass and increase the transparency and luster of glass. However, when the content of K₂O is too high, the crystallization ability of the glass becomes stronger, the glass is easy to lose its transparency, and the crystallized glass is easy to be damaged. In the microcrystalline glass of the present disclosure, the content of K₂O is 0~3.00 mol %. Specifically, the content of K₂O can be molar percentage content within a range such as 0.1 mol %-3.0 mol %, 0.5 mol %~2.5 mol %, 0.5 mol %~2.0 mol %, 0.5 mol %~1.5 mol %, 0.5 mol %~1.0 mol %, 1.0 mol %~2.5 mol %, 1.0 mol %~2.0 mol %, and 1.0 mol %~1.5 mol %, or can be a molar percentage content such as 0.5 mol %, 0.6 mol %, 0.7 mol %, 0.8 mol %, 0.9 mol %, 1.0 mol %, 1.1 mol %, 1.2 mol %, 1.3 mol %, 1.4 mol %, 1.5 mol %, 1.6 mol %, 1.7 mol %, 1.8 mol %, 1.9 mol %, 2.0 mol %, 2.1 mol %, 2.2 mol %, 2.3 mol %, 2.4 mol %, 2.5 mol %, 2.6 mol %, 2.7 mol %, 2.8 mol %, 2.9 mol %, and 3.0 mol %, or can be the molar percentage content within a range of values consisting of any two of the above specific values as endpoints. It should be understood that in a specific embodiment, any of the above ranges can be combined with any other range, as long as the glass with the required performance of the present disclosure can be obtained.

A proper amount of BaO is beneficial to reduce the viscosity of glass, improve the fusibility and formability of glass, and can also be configured to adjust the thermal expansion coefficient and the refractive index of microcrystalline glass. In the microcrystalline glass of the present disclosure, the content of BaO is 0~4.00 mol %. Specifically, the content of BaO can be molar percentage content within a range such as 0.1 mol %~4.0 mol %, 0.5 mol %~3.5 mol %, 0.5 mol %~3.0 mol %, 0.5 mol %~2.5 mol %, 0.5 mol %~2.0 mol %, 0.5 mol %~1.5 mol %, 0.5 mol %~1.0 mol %, 1.0 mol %~3.5 mol %, 1.0 mol %~3.0 mol %, 1.0 mol %~2.5 mol %, 1.0 mol %~2.0 mol %, 1.0 mol %~1.5 mol %, 1.5 mol %~3.5 mol %, 1.5 mol %~3.0 mol %, 1.5 mol %~2.5 mol %, and 1.5 mol %~2.0 mol %, or can be a molar percentage content such as 0.5 mol %, 0.6 mol %, 0.7 mol %, 0.8 mol %, 0.9 mol %, 1.0 mol %, 1.1 mol %, 1.2 mol %, 1.3 mol %, 1.4 mol %, 1.5 mol %, 1.6 mol %, 1.7 mol %, 1.8 mol %, 1.9 mol %, 2.0 mol %, 2.1 mol %, 2.2 mol %, 2.3 mol %, 2.4 mol %, 2.5 mol %, 2.6 mol %, 2.7 mol %, 2.8 mol %, 2.9 mol %, 3.0 mol %, 3.1 mol %, 3.2 mol %, 3.3 mol %, 3.3 mol %, 3.4 mol %, 3.5 mol %, 3.6 mol %, 3.7 mol %, 3.8 mol %, 3.9 mol %, and 4.0 mol %, or can be the molar percentage content within a range of values consisting of any two of the above specific values as endpoints. It should be understood that in a specific embodiment, any of the above ranges can be combined with any other range, as long as the glass with the required performance of the present disclosure can be obtained.

An appropriate amount of Y₂O₃ and/or La₂O₃ can enhance the densification degree of the glass phase, thereby enhancing the overall strength of the microcrystalline glass, and at the same time, it can form a eutectic with ZrO₂ to reduce the inhomogeneity caused by the sediment of ZrO₂ when melting in the furnace. However, the excessive content of Y₂O₃ will affect the precipitation of spinel crystals. In the microcrystalline glass of the present disclosure, the content of Y₂O₃ is 0~2 mol % and the content of La₂O₃ is 0~2 mol %. Specifically, the content of Y₂O₃ and La₂O₃ can each independently be a molar percentage content within range such as 0.1 mol %~2.0 mol %, 0.1 mol %~1.5 mol %, 0.1 mol %~1.0 mol %, 0.2 mol %~2.0 mol %, 0.2 mol %~1.5 mol %, 0.2 mol %~1.0 mol %, 0.3 mol %~2.0 mol %, 0.3 mol %~1.5 mol %, 0.3 mol %~1.0 mol %, 0.4 mol %~2.0 mol %, 0.4 mol %~1.5 mol %, 0.4 mol %~1.0 mol %, 0.5 mol %~2.0 mol %, 0.5 mol %~1.5 mol %, 0.5 mol %~1.0 mol %, 0.6 mol %~2.0 mol %, 0.6 mol %~1.5 mol %, 0.6 mol %~1.0 mol %, 0.7 mol %~2.0 mol %, 0.7 mol %~1.5 mol %, 0.7 mol %~1.0 mol %, 0.8 mol %~2.0 mol %, 0.8 mol %~1.5 mol %, 0.8 mol %~1.0 mol %, 0.9 mol %~2.0 mol %, 0.9 mol %~1.5 mol %, and 0.9 mol %~1.0 mol %, or can be a molar percentage content such as 0.1 mol %, 0.2 mol %, 0.3 mol %, 0.4 mol %, 0.5 mol %, 0.6 mol %, 0.7 mol %, 0.8 mol %, 0.9 mol %, 1.0 mol %, 1.1 mol %, 1.2 mol %, 1.3 mol %, 1.4 mol %, 1.5 mol %, 1.6 mol %, 1.7 mol %, 1.8 mol %, 1.9 mol %, and 2.0 mol %, or can be the molar percentage content within a range of values consisting of any two of the above specific values as endpoints. It should be understood that in a specific embodiment, any of the above ranges can be combined with any other range, as long as the glass with the required performance of the present disclosure can be obtained.

It is worth mentioning that the inventors found through a large number of experiments that the addition of Al₂O₃, ZrO₂, MgO, ZnO, Na₂O, K₂O Li₂O and SiO₂ has different effects on the temperature of crystallization. For example, SiO₂ will reduce the temperature of crystallization of spinel, Al₂O₃ will increase the temperature of crystallization of spinel, and the degree of the effect of each oxide on the temperature of crystallization is also different. For example, Al₂O₃ and SiO₂ have the greatest influence, followed by Li₂O and B₂O₃. The inventors reasonably match the contents of oxides such as Al₂O₃, Li₂O, Na₂O, B₂O₃, and ZrO₂ to meet specific relational requirements, such as Al₂O₃/(MgO+ZnO)=1.40~2.00 and (K₂O+Li₂O+Na₂O+B₂O₃)/(SiO₂+Al₂O₃)=0.10~0.20, Al₂O₃/SiO₂=0.50~0.80, Li₂O/(K₂O+Li₂O+Na₂O)=0.25~0.85, and Li₂O+Na₂O≥7.00 mol %, such that the heat treatment temperature required to prepare the target microcrystalline glass can be reduced, and the preparation of transparent zinc-magnesium-spinel microcrystalline glass with high intrinsic strength can be realized at the heat treatment temperature below 800° C., so as to improve the mass producibility of transparent spinel microcrystalline glass, and ensure the excellent optical properties of the target microcrystalline glass. At the same time, the microcrystalline glass of the present disclosure has high Young's modulus and hardness, and chemically strengthened microcrystalline glass with excellent drop resistance can be obtained by performing chemical strengthening on the microcrystalline glass.

In the second aspect, a preparation method for the above-mentioned microcrystalline glass is provided in the present disclosure, which includes the following steps.
(1) Preparation of base glass: based on the mole percentage of oxides, the base glass contains the following proportions of oxide components: SiO₂: 38.00%~50.00%, Al₂O₃: 25.00%~30.00%, MgO: 4.00%~8.00%, ZnO: 8.00%~14.00%, ZrO₂: 3.00%~5.00%, Li₂O: 3.00%~8.00% (excluding 8.00 mol %);
and the base glass does not contain TiO₂, wherein
the oxide component content of the base glass satisfies the following relational expressions:

$${Al}_{2} {O}_{3} / ( MgO + Z n O ) = 1.4 ∼ 2. ;$$

$$( {K}_{2} O + L {i}_{2} O + N {a}_{2} O + {B}_{2} {O}_{3} ) / ( Si {O}_{2} + {Al}_{2} {O}_{3} ) = 0.1 ∼ 0.2 .$$

(2) Preparation of microcrystalline glass: the base glass obtained in step (1) is subjected to heat treatment to obtain the above-mentioned microcrystalline glass.

In some alternative embodiments of the present disclosure, in step (2), the heat treatment includes a nucleation treatment and a crystallization treatment carried out sequentially, wherein the temperature of the nucleation treatment is 650° C.~850° C., preferably 650° C.~750° C., and the duration of the nucleation treatment is 0 h~72 h, preferably 0 h~24 h; and the temperature of the crystallization treatment is 700° C.~1000° C., preferably 700° C.~800° C., and the duration of the crystallization treatment is 0.1 h~72 h, preferably 0.1 h~24 h.

In some alternative embodiments of the present disclosure, based on the mole percentage of oxides, the base glass further contains the following proportions of oxide components: Na₂O: 0%~6.00%, K₂O: 0%~3.00%, B₂O₃: 0%~6.00%, BaO: 0%~4.00%, Y₂O₃: 0%~2.00%, La₂O₃: 0%~2.00%; and/or the content of oxide components, in terms of mol %, satisfies at least one of the following relational expressions: Al₂O₃/SiO₂-0.50~0.80; Li₂O/(K₂O+Li₂O+Na₂O)=0.25~0.85; and Li₂O+Na₂O≥7.00 mol %.

In some alternative embodiments of the present disclosure, the preparation method for the microcrystalline glass further includes the following step:
performing chemical strengthening treatment on the microcrystalline glass obtained by heat treatment, so as to obtain the microcrystalline glass containing a compressive stress layer.

In the third aspect, a base glass that can be configured to prepare the above-mentioned microcrystalline glass is provided in the present disclosure, and based on the mole percentage of oxides, the base glass contains oxide components in the following proportions: SiO₂: 38.00%~50.00%, Al₂O₃: 25.00%~30.00%, MgO: 4.00%~8.00%, ZnO: 8.00%~14.00%, ZrO₂: 3.00%~5.00%, Li₂O: 3.00%~8.00% (excluding 8.00 mol %); and the base glass does not contain TiO₂, wherein the oxide component content of the base glass satisfies the following relational expressions: Al₂O₃/(MgO+ZnO)=1.40~2.00; (K₂O+Li₂O+Na₂O+B₂O₃)/(SiO₂+Al₂O₃)=0.10~0.20.

In some alternative embodiments of the present disclosure, based on the mole percentage of oxides, the base glass further contains oxide components in the following proportions: Na₂O: 0%~6.00%, K₂O: 0%~3.00%, B₂O₃: 0%~6.00%, BaO: 0%~4.00%, Y₂O₃: 0%~2.00%, La₂O₃: 0%~2.00%; and/or the content of oxide components, in terms of mol %, satisfies at least one of the following relational expressions: Al₂O₃/SiO₂=0.50~0.80; Li₂O/(K₂O+Li₂O+Na₂O)=0.25~0.85; Li₂O+Na₂O≥7.00 mol %.

In the present disclosure, the molding methods for the base glass include but are not limited to floating, overflowing, calendering or casting processes. Exemplarily, the base glass is obtained by mixing evenly the components according to the formula, melt molding, and then cooling and annealing. When preparing the base glass, a clarifying agent can be added to the base glass, wherein the clarifying agent includes but is not limited to SnO₂, Sb₂O₃ and NaCl. Based on the mass of the base glass, the amount of the added clarifying agent is from 0.01 wt % to 2.00 wt %, and preferably from 0.01 wt % to 1.50 wt %.

In the fourth aspect, use of the above-mentioned microcrystalline glass in a mobile phone display screen, a tablet computer display screen, a handheld game console, an electronic terminal, a portable digital device, a vehicle-mounted central control screen, an electronic whiteboard glass, a smart home touch screen, a vehicle windshield glass, an aerocraft windshield glass or an aircraft windshield glass is provided in the present disclosure.

### Explanation for the Terms

1. Microcrystalline glass: also known as glass ceramics, is a kind of solid composite material containing both glass phase and crystal phase, which is prepared by targeted and controlled heat treatment for base glass. The crystal phase here is also referred to in other literature as the microcrystalline phase, crystalline phase, or the phase of crystal.
2. Base glass: refers to glass that has not been performed on nucleation treatment, crystallization treatment or strengthening treatment.
3. Chemically strengthened microcrystalline glass: refers to the solid composite material obtained by performing the chemical strengthening treatment on microcrystalline glass. When the high-temperature chemical strengthening treatment is performed, alkali metal ions with larger ionic radii (e.g., potassium ions, sodium ions) in the salt bath/molten salt replace alkali metal ions with smaller ionic radii (e.g., sodium ions, lithium ions) in the microcrystalline glass, resulting in an ion-exchange volume difference, so as to produce the compressive stress on the surface of the microcrystalline glass.
4. DOL_0: the depth of compressive stress layer, also known as the depth of compressive layer, refers to the distance from the surface of the glass to the position close to the surface where the compressive stress is zero.
5. |CT_AV|: the absolute value of the average tensile stress in the tensile stress layer, specifically refers to the absolute value of the average value of all tensile stresses in the tensile stress layer.

### Test Method:

1. Test conditions of |CT_AV| and DOL_0: SLP-2000 from Orihara, Japan is adopted for the test. The wavelength of the light source is 518 nm, SOC=25.5 (nm/cm)/MPa, the refractive index=1.60, and the exposure time is 300 usec, wherein SOC is the photoelastic coefficient, and photoelasticity mainly refers to the phenomenon of the anisotropic birefringence of transparent materials after being stressed. The value of residual stress (MPa) inside the materials can be obtained through the coefficient of photoelasticity and the measurement of birefringence.
2. Thickness of glass: is determined by micrometer testing. Before and after chemical strengthening, the degree of ion exchange in the thickness direction of the glass sample changes in gradient from the surface to the center and the whole exchange capacity of Na—K and/or Li—Na is generally not more than 1% of the total mass of the sample, and the difference of ion radius is of pm (picometer) level, so the expansion effect in the thickness direction is extremely slight, which can be approximately considered that the thickness is basically unchanged.
3. Differential scanning calorimetry (DSC) test: the sample is ground and then sieved through a 200-mesh sieve (Taylor standard sieve, USA); the test condition is: room temperature to 1100° C. with the heating rate of 10° C./min; the testing instrument is METTLER TOLEDO TGA/DSC3+ thermogravimetric and synchronous thermal analyzer; the standard material adopted in the test is α-Al₂O₃ powder; and the ambient temperature of the instrument is 24° C. and the air humidity is 40%.
4. Average grain size: the microcrystalline glass samples are tested by adopting an X-ray diffractometer, and the resultant data obtained from the XRD test is adopted to calculate the average grain size of the samples by using Scherrer formula D=Kλ/(β cos θ), wherein λ is the X-ray wavelength of 0.154056 nm, B is the full width at half maximum of the diffraction peak, K=0.89, and 0 is the Bragg diffraction angle. Exemplarily, the file of the RAW (diffraction pattern) output from the XRD instrument is curve-fitted in Jade software, and Jade outputs a fitting report. Based on the angle 20 value and Peak FWHM value corresponding to each diffraction peak in the fitting report, with converting the Peak FWHM value to the radian system: β=(FWHM/180×3.14), the grain size of each diffraction peak is calculated by Scherrer formula D=Kλ/(β cos θ), and then the grain sizes are averaged to obtain the average grain size. The X-ray diffractometer adopted in the present disclosure is Shimadzu XRD-6100, the target material is copper, the test incidence angle range is 2θ=10~80°, the scanning speed is 6°/min, the working voltage is 40 kV and the working current is 30 mA.
5. Optical property test: referring to the standard of GB/T 7962.12-2010 Test methods for colorless optical glass-Part 12: Internal transmittance, the transmittance, a* value and b* value of microcrystalline glass are tested by professional testing instruments. The testing instrument adopted in the present disclosure is the spectrocolorimeter CM-3600A (Konica Minolta, Japan).
6. Crystallinity test: X-ray diffractometer is adopted to test the microcrystalline glass sample to obtain the XRD test result, and then the test result file (in RAW format) of the X-ray diffractometer is imported into the Rietveld refinement software for X-ray diffraction data (such as Gsas, Fullprof or Maud) for fitting and calculation, so that the crystallinity of the microcrystalline glass sample can be obtained, and the ratio of the fitted crystalline phase peak area to the fitted total peak area is the crystallinity. The X-ray diffractometer adopted in the present disclosure is Shimadzu XRD-6100, and the test incidence angle range is 2θ=10~80°, the scanning speed is 6°/min, the working voltage is 40 kV and the working current is 30 mA. In the present disclosure, the measured crystallinity of the microcrystalline glass sample is the weight ratio of the crystal phase of the microcrystalline glass to the microcrystalline glass.
7. Average anti-abrasive-paper drop height: is the value obtained by dividing the sum of anti-abrasive-paper drop heights measured by multiple glass samples by the number of samples measured, which is adopted to characterize the drop resistance of microcrystalline glass.

Taking at least 10 samples from each batch for testing, the average anti-abrasive-paper drop height is:

$$〈 h 〉 n = \frac{1}{n} {\sum }_{i = 1}^{n} hi ,$$

wherein
n is the number of sample plates of glass tested in each batch, and hi is the anti-abrasive-paper drop height of a single sample plate.
The test method of the anti-abrasive-paper drop height of the sample is as follows.
Step 1: attaching 80-mesh abrasive paper on the lower surface of the 160 g model machine, and placing the model machine on the GreenMap LT-SKDL-CD drop tester.
Step 2: placing the glass sample to be tested with a length, width and thickness of 50 mm×50 mm×0.7 mm directly under the model machine, so that the glass sample faces the abrasive paper, and making the model machine impact and drop at a certain drop height, so as to impact the glass sample directly below the model machine. If the glass sample is not broken, the drop height of the model machine is raised according to a certain rule. For example, the drop height starts from 0.4 m, and a drop impact is performed on the sample once, and if it is not broken, the height of 0.1 m is raised each time and dropping is performed again until the glass sample is broken.
Step 3: recording the previous drop height of the glass sample when it is broken as the anti-abrasive-paper drop height. For example, if the drop height when the glass sample is broken is 0.5 m, the anti-abrasive-paper drop height of the sample is 0.4 m.
8. Vickers hardness test: the plate of chemically strengthened microcrystalline glass is made into small pieces of 50 mm×50 mm×0.7 mm, and the sample plate of glass with clean surface free of scratches, pits, cracks and other damage visible to the naked eye is selected as a specimen, and then Vickers hardness is measured by Vickers hardness tester. Three different positions on the surface of the same piece of specimen are selected for measurement, and then the average of three times of measurement is taken as the final test result. The Vickers hardness tester adopted in the present disclosure is a digital low-load Vickers hardness tester (Beijing Kewei Technology Co., Ltd., VTD405), with a load of 300 gf and a load duration of 10 s, and the validity of indentation conforms to GB/T16534.
9. Young's modulus test: Young's modulus E is a value measured by a well-known resonance method.
10. Fracture toughness test: the test is performed with reference to the test method of Vickers hardness, and the fracture toughness value is calculated by formula:

$${K}_{1 C} = 0.004985 * {( \frac{E}{Hv} )}^{0.5} * P / {C}^{1.5} ,$$

wherein
E is Young's modulus and the unit is GPa; Hv is Vickers hardness and the unit is GPa (1 GPa=102.04 kgf/mm²); P is the load and the unit is kg; C is the average length of crack.
11. Refractive index test: in the present disclosure, a single-port Abbe refractometer (WYA-2WAJ, Bell Analytical Instruments Co., Ltd.) is adopted, and the wavelength is set at 589 nm to test the refractive index of the plate of the microcrystalline glass.

The microcrystalline glass of the present disclosure is described in detail below with specific examples.

### EXAMPLE

I. The base glass was prepared by melting.

1000 g of raw materials were prepared according to the formula shown in Tables 2A, 2B and 2C, which were adopted as the raw material for the preparation of the base glass; then the raw materials were mixed with a V-mixer for 30 minutes, and after mixed evenly, the clarifying agent (NaCl) of 5 g was added; after that, the raw materials were transferred to a platinum crucible and were melted in a lifting furnace at 1650° C. for 5 hours, then the resultant was poured into a forming mold for molding and cooling, and the resultant was cooled to 900° C.; then the resultant was placed in a 600° C. annealing furnace for annealing for 24 hours, and then the resultant was cooled to room temperature with the furnace, so as to obtain the base glasses D1-D10 and S1-S17.
II. The base glass was performed on heat treatment to prepare the microcrystalline glass.

The base glasses D1-D10 and S1-S17 in process (1) were sequentially performed on heat treatment according to the parameter conditions shown in the heat treatment processes R₁-R₁₀ in Table 3, so as to prepare the sample brick of microcrystalline glass. The specific heat treatment processes of various base glasses and the obtained results of the states of microcrystalline glass are shown in Tables 4A, 4B, 4C and 4D, and the microcrystalline glasses with Experiment No. 1-35 are shown in Tables 4A~4D.
III. The sample plate was processed.

The sample brick of microcrystalline glass was performed on shaping, cutting and polishing, so as to obtain the sample of a desired size, such as the sample plate of microcrystalline glass with a length, width and thickness of 50 mm×50 mm×0.7 mm.
IV. The microcrystalline glass was performed on chemical strengthening, so as to prepare the microcrystalline glass containing the compressive stress layer (that is, chemically strengthened microcrystalline glass).

The sample plate of microcrystalline glass obtained in process (3) was performed on chemical strengthening in the strengthening salt bath with the compositions shown in Tables 5A-5C and under the conditions of strengthening temperature and duration, so as to obtain the chemically strengthened microcrystalline glass. Sodium ions in the salt bath were provided by sodium nitrate and potassium ions were provided by potassium nitrate. Specifically, the composition of salt bath in Tables 5A-5C was specifically only sodium nitrate, which constituted a salt bath for strengthening, or the composition of salt bath in Tables 5A-5C was a mixture of sodium nitrate and potassium nitrate, which constituted a salt bath for strengthening, wherein when the mixture of sodium nitrate and potassium nitrate constituted a salt bath, the mass concentration of sodium nitrate ranged from 30~100 wt %, and specifically can be 30~70 wt %.

The physical parameters of each chemically strengthened microcrystalline glass after specific chemical strengthening are shown in Tables 5A-5C.

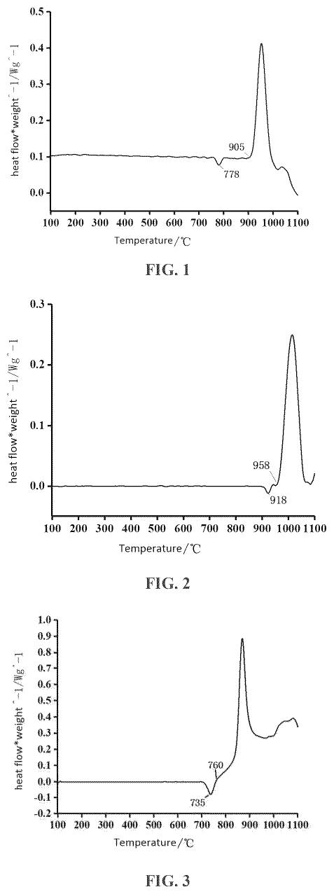

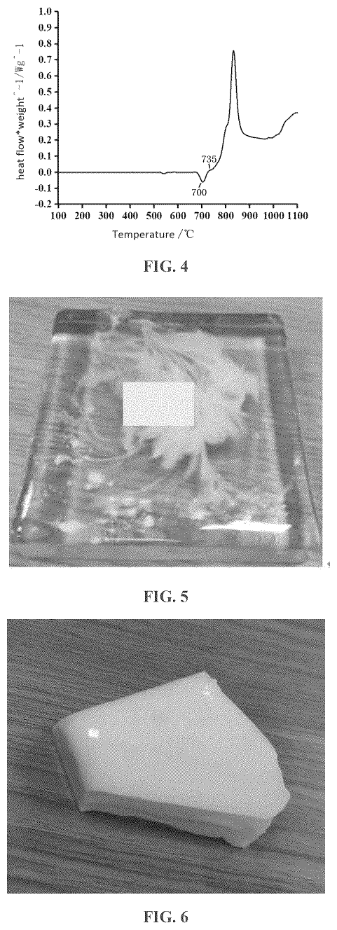

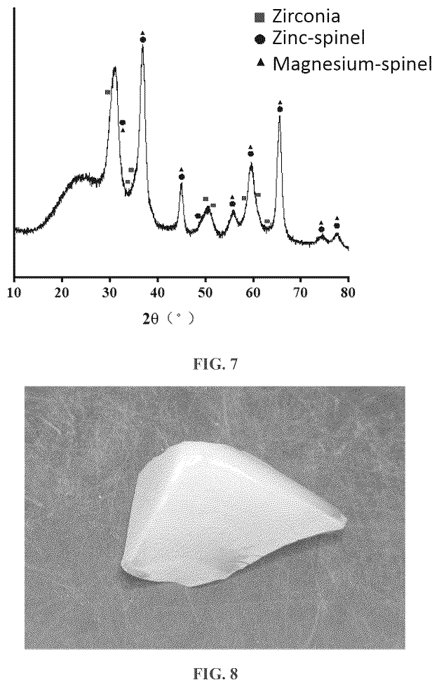

In addition, FIG. 1 is a DSC test graph of base glass D3, from which it can be seen that its nucleation temperature is about 778° C. and the initial crystallization temperature is about 905° C. FIG. 2 is a DSC test graph of base glass D4, from which it can be seen that its nucleation temperature is about 918° C. and the initial crystallization temperature is about 958° C. FIG. 3 is a DSC test graph of base glass S3, from which it can be seen that its nucleation temperature is about 735° C. and the initial crystallization temperature is about 760° C. FIG. 4 is a DSC test graph of base glass S5, from which it can be seen that its nucleation temperature is about 700° C., and the initial crystallization temperature is about 735° C. FIG. 5 is a brick-forming picture of base glass D1, wherein since the content of Zr is too high, a large amount of white sediment is present on the surface of the base glass after melting. FIG. 6 is a picture of a microcrystalline glass sample corresponding to Experiment No. 3, and it can be seen that since the content of Li in the component is too high, a crystal of a quartz solid solution (MgAl₂Si₃O₁₀) appears in the crystallized microcrystalline glass, resulting in the overall devitrification of the microcrystalline glass. FIG. 7 is an XRD test graph of a microcrystalline glass corresponding to Experiment No. 19, and it can be seen that the crystallization of the microcrystalline glass is complete and has no impurity phases. FIG. 8 is a picture of a microcrystalline glass sample corresponding to Experiment No. 18, and it can be seen that since the content of Al is relatively low, a small amount of quartz crystals appear after crystallization, which appears as a fogging sample plate.

TABLE 2A
Glass Formulation and Melting State (I)

| No. of | | | | | | | | | | |
|---|---|---|---|---|---|---|---|---|---|---|
| glass | | | | | | | | | | |
| formu- | | | | | | | | | | |
| lation | | | | | | | | | | |
| and | | | | | | | | | | |
| corres- | | | | | | | | | | |
| ponding | | | | | | | | | | |
| compo- | | | | | | | | | | |
| sition | | | | | | | | | | |
| (mol %) | D1 | D2 | D3 | D4 | D5 | D6 | D7 | D8 | D9 | D10 |
| SiO₂ | 44.75% | 46.61% | 53.33% | 54.18% | 40.26% | 45.63% | 45.28% | 43.34% | 38.99% | 48.39% |
| A1₂O₃ | 25.34% | 21.82% | 20.44% | 19.11% | 32.99% | 26.24% | 25.92% | 25.72% | 27.94% | 24.09% |
| TiO₂ | 0.00% | 0.00% | 0.00% | 0.88% | 0.00% | 0.00% | 0.00% | 0.00% | 0.00% | 0.00% |
| ZrO₂ | 5.31% | 3.71% | 3.24% | 3.19% | 3.16% | 2.92% | 4.43% | 3.46% | 3.34% | 3.57% |
| MgO | 5.80% | 7.30% | 5.48% | 5.61% | 6.07% | 5.95% | 5.92% | 5.78% | 5.57% | 5.96% |
| ZnO | 10.10% | 10.40% | 9.54% | 9.76% | 10.70% | 10.35% | 10.15% | 9.91% | 9.57% | 10.22% |
| Na₂O | 3.00% | 1.66% | 2.55% | 2.61% | 1.89% | 3.08% | 3.55% | 6.08% | 3.20% | 3.14% |
| K₂O | 0.00% | 0.00% | 0.00% | 0.00% | 0.00% | 0.00% | 0.19% | 0.00% | 0.00% | 0.00% |
| Li₂O | 4.00% | 8.00% | 3.79% | 3.00% | 3.33% | 4.10% | 2.86% | 4.06% | 4.12% | 3.44% |
| B₂O₃ | 0.50% | 0.50% | 0.50% | 0.50% | 0.47% | 0.50% | 0.50% | 0.50% | 6.16% | 0.00% |
| BaO | 1.20% | 0.00% | 1.13% | 1.16% | 1.13% | 1.23% | 1.20% | 1.15% | 1.11% | 1.19% |
| Y₂O₃ | 0.00% | 0.00% | 0.00% | 0.00% | 0.00% | 0.00% | 0.00% | 0.00% | 0.00% | 0.00% |
| La₂O₃ | 0.00% | 0.00% | 0.00% | 0.00% | 0.00% | 0.00% | 0.00% | 0.00% | 0.00% | 0.00% |
| In total | 100% | 100% | 100% | 100% | 100% | 100% | 100% | 100% | 100% | 100% |
| Al₂O₃/ | 1.59 | 1.23 | 1.36 | 1.24 | 1.97 | 1.61 | 1.61 | 1.64 | 1.85 | 1.49 |
| (MgO + | | | | | | | | | | |
| ZnO) | | | | | | | | | | |
| (K₂O + | 0.11 | 0.15 | 0.09 | 0.08 | 0.08 | 0.11 | 0.10 | 0.15 | 0.20 | 0.09 |
| Li₂O + | | | | | | | | | | |
| Na₂O + | | | | | | | | | | |
| B₂O₃)/ | | | | | | | | | | |
| (SiO₂ + | | | | | | | | | | |
| A1₂O₃) | | | | | | | | | | |
| A1₂O₃/ | 0.57 | 0.47 | 0.38 | 0.35 | 0.82 | 0.57 | 0.57 | 0.59 | 0.72 | 0.50 |
| SiO₂ | | | | | | | | | | |
| Li₂O/ | 0.57 | 0.83 | 0.60 | 0.53 | 0.64 | 0.57 | 0.43 | 0.40 | 0.56 | 0.52 |
| (K₂O + | | | | | | | | | | |
| Li₂O + | | | | | | | | | | |
| Na₂O) | | | | | | | | | | |
| Li₂O + | 7.00% | 9.66% | 6.34% | 5.61% | 5.22% | 7.18% | 6.41% | 10.14% | 7.32% | 6.58% |
| Na₂O | | | | | | | | | | |
| Melting | Lots of | Normal | Normal | Yellowed | Lots of | Normal | Normal | Ceramized | Normal | Normal |
| State | white | | | | unmelted | | | | | |
| | sediments | | | | materials | | | | | |

TABLE 2B
Glass Formulation and Melting State (II)

| No. of | | | | | | | | | | |
|---|---|---|---|---|---|---|---|---|---|---|
| glass | | | | | | | | | | |
| formu- | | | | | | | | | | |
| lation | | | | | | | | | | |
| and | | | | | | | | | | |
| corres- | | | | | | | | | | |
| ponding | | | | | | | | | | |
| compo- | | | | | | | | | | |
| sition | | | | | | | | | | |
| (mol %) | S1 | S2 | S3 | S4 | S5 | S6 | S7 | S8 | S9 | S10 |
| SiO₂ | 45.28% | 45.58% | 44.01% | 46.53% | 39.21% | 45.68% | 38.76% | 45.12% | 44.98% | 45.36% |
| Al₂O₃ | 25.91% | 26.09% | 25.36% | 26.62% | 28.31% | 26.34% | 29.15% | 25.43% | 25.93% | 25.96% |
| TiO₂ | 0.00% | 0.00% | 0.00% | 0.00% | 0.00% | 0.00% | 0.00% | 0.00% | 0.00% | 0.00% |
| ZrO₂ | 3.54% | 3.57% | 4.29% | 3.64% | 3.36% | 4.45% | 3.32% | 4.30% | 4.38% | 3.55% |
| MgO | 5.91% | 5.95% | 4.21% | 6.07% | 5.61% | 4.37% | 5.54% | 7.65% | 5.85% | 5.92% |
| ZnO | 10.14% | 10.21% | 13.49% | 8.37% | 9.62% | 10.20% | 9.51% | 8.85% | 10.04% | 10.16% |
| Na₂O | 1.58% | 3.57% | 3.43% | 3.64% | 3.02% | 3.57% | 2.98% | 3.44% | 3.51% | 1.58% |
| K₂O | 0.00% | 0.00% | 0.19% | 0.00% | 0.00% | 0.19% | 0.00% | 0.19% | 0.19% | 0.00% |
| Li₂O | 5.97% | 5.03% | 3.88% | 5.13% | 4.15% | 4.02% | 4.10% | 3.88% | 3.96% | 5.99% |
| B₂O₃ | 0.00% | 0.00% | 0.19% | 0.00% | 5.60% | 0.19% | 5.53% | 0.19% | 0.19% | 0.00% |
| BaO | 0.00% | 0.00% | 0.95% | 0.00% | 1.12% | 0.99% | 1.11% | 0.95% | 0.97% | 0.00% |
| Y₂O₃ | 0.00% | 0.00% | 0.00% | 0.00% | 0.00% | 0.00% | 0.00% | 0.00% | 0.00% | 1.48% |
| La₂O₃ | 1.67% | 0.00% | 0.00% | 0.00% | 0.00% | 0.00% | 0.00% | 0.00% | 0.00% | 0.00% |
| In total | 100.00% | 100.00% | 100.00% | 100.00% | 100.00% | 100.00% | 100.00% | 100.00% | 100.00% | 100.00% |
| Al₂O₃/ | 1.61 | 1.61 | 1.43 | 1.84 | 1.86 | 1.81 | 1.94 | 1.54 | 1.63 | 1.61 |
| (MgO + | | | | | | | | | | |
| ZnO) | | | | | | | | | | |
| (K₂O + | 0.11 | 0.12 | 0.11 | 0.12 | 0.19 | 0.11 | 0.19 | 0.11 | 0.11 | 0.11 |
| Li₂O + | | | | | | | | | | |
| Na₂O + | | | | | | | | | | |
| B₂O₃)/ | | | | | | | | | | |
| (SiO₂ + | | | | | | | | | | |
| Al₂O₃) | | | | | | | | | | |
| Al₂O₃/ | 0.57 | 0.57 | 0.58 | 0.57 | 0.72 | 0.58 | 0.75 | 0.56 | 0.58 | 0.57 |
| SiO₂ | | | | | | | | | | |
| Li₂O/ | 0.79 | 0.58 | 0.52 | 0.58 | 0.58 | 0.52 | 0.58 | 0.52 | 0.52 | 0.79 |
| (K₂O + | | | | | | | | | | |
| Li₂O + | | | | | | | | | | |
| Na₂O) | | | | | | | | | | |
| Li₂O + | 7.55% | 8.60% | 7.31% | 8.77% | 7.17% | 7.59% | 7.08% | 7.32% | 7.47% | 7.57% |
| Na₂O | | | | | | | | | | |
| Melting | Normal | Normal | Normal | Normal | Normal | Normal | Normal | Normal | Normal | Normal |
| State | | | | | | | | | | |

TABLE 2C
Glass Formulation and Melting State (III)

| No. of | | | | | | | |
|---|---|---|---|---|---|---|---|
| glass | | | | | | | |
| formu- | | | | | | | |
| lation | | | | | | | |
| and | | | | | | | |
| corres- | | | | | | | |
| ponding | | | | | | | |
| compo- | | | | | | | |
| sition | | | | | | | |
| (mol %) | S11 | S12 | S13 | S14 | S15 | S16 | S17 |
| SiO₂ | 46.03% | 44.01% | 45.58% | 44.79% | 48.11% | 45.23% | 43.40% |
| Al₂O₃ | 26.35% | 25.00% | 26.09% | 25.40% | 25.38% | 25.88% | 25.15% |
| TiO₂ | 0.00% | 0.00% | 0.00% | 0.00% | 0.00% | 0.00% | 0.00% |
| ZrO₂ | 3.60% | 3.44% | 3.57% | 3.50% | 3.34% | 3.54% | 3.79% |
| MgO | 6.01% | 5.74% | 5.95% | 5.85% | 5.57% | 5.90% | 5.69% |
| ZnO | 10.32% | 9.86% | 10.21% | 10.03% | 9.55% | 10.13% | 9.77% |
| Na₂O | 1.61% | 5.36% | 5.55% | 4.47% | 1.49% | 1.58% | 3.41% |
| K₂O | 0.00% | 0.00% | 0.00% | 2.75% | 0.00% | 0.00% | 0.00% |
| Li₂O | 6.08% | 3.12% | 3.05% | 3.21% | 5.63% | 7.74% | 3.86% |
| B₂O₃ | 0.00% | 0.00% | 0.00% | 0.00% | 0.93% | 0.00% | 3.79% |
| BaO | 0.00% | 3.47% | 0.00% | 0.00% | 0.00% | 0.00% | 1.14% |
| Y₂O₃ | 0.00% | 0.00% | 0.00% | 0.00% | 0.00% | 0.00% | 0.00% |
| La₂O₃ | 0.00% | 0.00% | 0.00% | 0.00% | 0.00% | 0.00% | 0.00% |
| In total | 100.00% | 100.00% | 100.00% | 100.00% | 100.00% | 100.00% | 100.00% |
| Al₂O₃/ | 1.61 | 1.60 | 1.61 | 1.60 | 1.68 | 1.61 | 1.63 |
| (MgO + | | | | | | | |
| ZnO) | | | | | | | |
| (K₂O + | 0.11 | 0.12 | 0.12 | 0.15 | 0.11 | 0.13 | 0.16 |
| Li₂O + | | | | | | | |
| Na₂O + | | | | | | | |
| B₂O₃)/ | | | | | | | |
| (SiO₂ + | | | | | | | |
| Al₂O₃) | | | | | | | |
| Al₂O₃/ | 0.57 | 0.57 | 0.57 | 0.57 | 0.53 | 0.57 | 0.58 |
| SiO₂ | | | | | | | |
| Li₂O/ | 0.79 | 0.37 | 0.35 | 0.31 | 0.79 | 0.83 | 0.53 |
| (K₂O + | | | | | | | |
| Li₂O + | | | | | | | |
| Na₂O) | | | | | | | |
| Li₂O + | 7.69% | 8.48% | 8.60% | 7.68% | 7.12% | 9.32% | 7.27% |
| Na₂O | | | | | | | |
| Melting | Normal | Normal | Normal | Normal | Normal | Normal | Normal |
| State | | | | | | | |

According to the data in the above tables 2A-2C, it can be seen that due to the excessive high content of ZrO₂, after the base glass D1 is melted, a large number of white sediments appears; due to containing TiO₂, the whole base glass D4 turns yellow after being melted; due to the excessive high content of Al₂O₃, the base glass D5 has a lot of unmelted materials during being melted; and due to the excessive high content of Na₂O, the base glass D8 has been ceramized after being annealed. The melting of the rest formulations is normal.

TABLE 3
Parameters of Heat Treatment Process

| No. of heat | | |
|---|---|---|
| treatment | Brief | |
| process | description | Detailed description |
| R1 | 750° C.-4 h | Raising the temperature from room temperature to 750° C. at 10° C./min, |
| | | keeping the temperature for 4 h, and then cooling down with the furnace |
| | | to room temperature. |
| R2 | 790° C.-4 h | Raising the temperature from room temperature to 790° C. at 10° C./min, |
| | | keeping the temperature for 4 h, and then cooling down with the furnace |
| | | to room temperature. |
| R3 | 850° C.-4 h | Raising the temperature from room temperature to 850° C. at 10° C./min, |
| | | keeping the temperature for 4 h, and then cooling down with the furnace |
| | | to room temperature. |
| R4 | 900° C.-4 h | Raising the temperature from room temperature to 900° C. at 10° C./min, |
| | | keeping the temperature for 4 h, and then cooling down with the furnace |
| | | to room temperature. |
| R5 | 950° C.-4 h | Raising the temperature from room temperature to 950° C. at 10° C./min, |
| | | keeping the temperature for 4 h, and then cooling down with the furnace |
| | | to room temperature. |
| R6 | Nucleation | Raising the temperature from room temperature to nucleation temperature |
| | temperature-4 h- | at 10° C./min, keeping the temperature for 4 h, then raising the temperature |
| | 750° C.-4 h | to 750° C. at 10° C./min, keeping the temperature for 4 h, and then cooling |
| | | down with the furnace to room temperature. |
| R7 | Nucleation | Raising the temperature from room temperature to nucleation temperature |
| | temperature-4 h- | at 10° C./min, keeping the temperature for 4 h, then raising the temperature |
| | 790° C.-4 h | to 790° C. at 10° C./min, keeping the temperature for 4 h, and then cooling |
| | | down with the furnace to room temperature. |
| R8 | Nucleation | Raising the temperature from room temperature to nucleation temperature |
| | temperature-4 h- | at 10° C./min, keeping the temperature for 4 h, then raising the temperature |
| | 850° C.-4 h | to 850° C. at 10° C./min, keeping the temperature for 4 h, and then cooling |
| | | down with the furnace to room temperature. |
| R9 | Nucleation | Raising the temperature from room temperature to nucleation temperature |
| | temperature-4 h- | at 10° C./min, keeping the temperature for 4 h, then raising the temperature |
| | 900° C.-4 h | to 900° C. at 10° C./min, keeping the temperature for 4 h, and then cooling |
| | | down with the furnace to room temperature. |
| R10 | Nucleation | Raising the temperature from room temperature to nucleation temperature |
| | temperature-4 h- | at 10° C./min, keeping the temperature for 4 h, then raising the temperature |
| | 950° C.-4 h | to 950° C. at 10° C./min, keeping the temperature for 4 h, and then cooling |
| | | down with the furnace to room temperature. |

Nucleation Temperature: After the glass is melted and annealed, the sample is sent for DSC testing. The temperature corresponding to the highest point of the endothermic peak in the DSC curve is identified as the nucleation temperature
(Note:
Single nucleation treatment is not always required).

TABLE 4A
Heat Treatment Process and Results of States of Microcrystalline Glass (I)

| No. of | | | | | | | | | | | |
|---|---|---|---|---|---|---|---|---|---|---|---|
| Experiment | | 1 | 2 | 3 | 4 | 5 | 6 | 7 | 8 | 9 | 10 |
| No. of Glass | | D2 | D2 | D2 | D2 | D3 | D3 | D3 | D3 | D4 | D4 |
| Formulation | | | | | | | | | | | |
| No. of Heat | | R₁ | R₂ | R₅ | R₁₀ | R₂ | R₃ | R₈ | R₄ | R₃ | R₄ |
| Treatment | | | | | | | | | | | |
| Process | | | | | | | | | | | |
| Nucleation | | / | / | / | 821 | / | / | 778 | / | / | / |
| Temperature/ | | | | | | | | | | | |
| ° C. | | | | | | | | | | | |
| Crystal | Crystal | ZrO₂ | MgAl₂ | MgAl₂ | MgAl₂ | ZrO₂ | (Zn, | (Zn, | (Zn, | ZrO₂ | (Zn, |
| Phase | Phase | | Si₃O₁₀ | Si₃O₁₀ | Si₃O₁₀ | | Mg) | Mg) | Mg) | | Mg) |
| | A | | | | | | Al₂O₄ | Al₂O₄ | Al₂O₄ | | Al₂O₄ |
| | Crystal | / | (Zn, | (Zn, | (Zn, | / | ZrO₂ | ZrO₂ | ZrO₂ | / | ZrO₂ |
| | Phase | | Mg) | Mg) | Mg) | | | | | | |
| | B | | Al₂O₄ | Al₂O₄ | Al₂O₄ | | | | | | |
| | Crystal | / | ZrO₂ | ZrO₂ | ZrO₂ | / | / | / | / | / | / |
| | Phase | | | | | | | | | | |
| | C | | | | | | | | | | |

| | | | | | | | | | | |
|---|---|---|---|---|---|---|---|---|---|---|
| Crystallinity/ | 2.3% | 65.5% | 85.8% | 63.4% | 3.8% | 17.6% | 18.3% | 35.7% | 3.2% | 16.9% |
| wt % | | | | | | | | | | |
| Avg. Grain | 2.1 | 35.6 | 120.3 | 32.3 | 2.4 | 4.8 | 5.1 | 6.4 | 1.9 | 5.7 |
| Size/nm | | | | | | | | | | |
| State after | Trans- | Severe | Cera- | Severe | Trans- | Trans- | Trans- | Trans- | Yel- | Browned |
| Heat | parent | Fogging | mized | Fogging | parent | parent | parent | parent | lowed | |
| Treatment | | | | | | | | | | |

TABLE 4B
Heat Treatment Process and Results of States of Microcrystalline Glass (II)

| No. of | | | | | | | | | | | |
|---|---|---|---|---|---|---|---|---|---|---|---|
| Experiment | | 11 | 12 | 13 | 14 | 15 | 16 | 17 | 18 | 19 | 20 |
| No. of Glass | | D4 | D4 | D6 | D6 | D7 | D9 | D9 | D10 | S1 | S2 |
| Formulation | | | | | | | | | | | |
| No. of Heat | | R₅ | R₁₀ | R₁ | R₆ | R₆ | R₁ | R₆ | R₂ | R₆ | R₆ |
| Treatment | | | | | | | | | | | |
| Process | | | | | | | | | | | |
| Nucleation | | / | 918 | / | 716 | 711 | / | 703 | / | 718 | 713 |
| Temperature/ | | | | | | | | | | | |
| ° C. | | | | | | | | | | | |
| Crystal | Crystal | (Zn, | (Zn, | (Zn, | (Zn, | (Zn, | (Zn, | (Zn, | (Zn, | (Zn, | (Zn, |
| Phase | Phase | Mg) | Mg) | Mg) | Mg) | Mg) | Mg) | Mg) | Mg) | Mg) | Mg) |
| | A | Al₂O₄ | Al₂O₄ | Al₂O₄ | Al₂O₄ | Al₂O₄ | Al₂O₄ | Al₂O₄ | Al₂O₄ | Al₂O₄ | Al₂O₄ |
| | Crystal | ZrO₂ | ZrO₂ | ZrO₂ | ZrO₂ | ZrO₂ | ZrO₂ | ZrO₂ | ZrO₂ | ZrO₂ | ZrO₂ |
| | Phase | | | | | | | | | | |
| | B | | | | | | | | | | |
| | Crystal | / | / | / | / | / | / | / | MgAl₂ | / | / |
| | Phase | | | | | | | | Si₃O₁₀ | | |
| | C | | | | | | | | | | |

| | | | | | | | | | | |
|---|---|---|---|---|---|---|---|---|---|---|
| Crystallinity/ | 34.6% | 35.2% | 34.6% | 34.1% | 33.8% | 33.6% | 34.1% | 39.2% | 32.5% | 33.7% |
| wt % | | | | | | | | | | |
| Average Grain | 5.9 | 5.3 | 6.9 | 7.8 | 6.4 | 8.9 | 5.9 | 11.5 | 5.8 | 6.5 |
| Size/nm | | | | | | | | | | |
| State after | Browned | Browned | Severe | Fog- | Trans- | Fog- | Slight | Fog- | Trans- | Trans- |
| Heat | | | Fog- | ging | parent | ging | Fog- | ging | parent | parent |
| Treatment | | | ging | | | | ging | | | |

TABLE 4C
Heat Treatment Process and Results of States of Microcrystalline Glass (III)

| No. of | | | | | | | | | | | |
|---|---|---|---|---|---|---|---|---|---|---|---|
| Experiment | | 21 | 22 | 23 | 24 | 25 | 26 | 27 | 28 | 29 | 30 |
| No. of Glass | | S3 | S4 | S5 | S6 | S7 | S8 | S9 | S10 | S11 | S12 |
| Formulation | | | | | | | | | | | |
| No. of Heat | | R₇ | R₆ | R₆ | R₆ | R₆ | R₇ | R₆ | R₆ | R₇ | R₇ |
| Treatment | | | | | | | | | | | |
| Process | | | | | | | | | | | |
| Nucleation | | 735 | 722 | 700 | 721 | 713 | 740 | 716 | 719 | 735 | 738 |
| Temperature/ | | | | | | | | | | | |
| ° C. | | | | | | | | | | | |
| Crystal | Crystal | (Zn, | (Zn, | (Zn, | (Zn, | (Zn, | (Zn, | (Zn, | (Zn, | (Zn, | (Zn, |
| Phase | Phase | Mg) | Mg) | Mg) | Mg) | Mg) | Mg) | Mg) | Mg) | Mg) | Mg) |
| | A | Al₂O₄ | Al₂O₄ | Al₂O₄ | Al₂O₄ | Al₂O₄ | Al₂O₄ | Al₂O₄ | A1₂O₄ | A1₂O₄ | Al₂O₄ |
| | Crystal | ZrO₂ | ZrO₂ | ZrO₂ | ZrO₂ | ZrO₂ | ZrO₂ | ZrO₂ | ZrO₂ | ZrO₂ | ZrO₂ |
| | Phase | | | | | | | | | | |
| | B | | | | | | | | | | |
| | Crystal | / | / | / | / | / | / | / | / | / | / |
| | Phase | | | | | | | | | | |
| | C | | | | | | | | | | |

| | | | | | | | | | | |
|---|---|---|---|---|---|---|---|---|---|---|
| Crystallinity/ | 35.8% | 33.9% | 34.1% | 34.8% | 33.9% | 34.5% | 35.9% | 36.4% | 34.2% | 35.7% |
| wt % | | | | | | | | | | |
| Average Grain | 5.7 | 6.4 | 5.6 | 5.3 | 5.2 | 6.2 | 5.9 | 5.5 | 5.4 | 5.9 |
| Size/nm | | | | | | | | | | |
| State after | Trans- | Trans- | Trans- | Trans- | Trans- | Trans- | Trans- | Trans- | Trans- | Trans- |
| Heat | parent | parent | parent | parent | parent | parent | parent | parent | parent | parent |
| Treatment | | | | | | | | | | |

TABLE 4D
Heat Treatment Process and Results of States of Microcrystalline Glass (IV)

| No. of Experiment | | 31 | 32 | 33 | 34 | 35 |
|---|---|---|---|---|---|---|
| No. of Glass | | S13 | S14 | S15 | S16 | S17 |
| Formulation | | | | | | |
| No. of Heat Treatment | | R₆ | R₇ | R₇ | R₆ | R₇ |
| Process | | | | | | |
| Nucleation | | 725 | 743 | 737 | 709 | 742 |
| Temperature /° C. | | | | | | |
| Crystal | Crystal | (Zn, | (Zn, | (Zn, | (Zn, | (Zn, |
| Phase | Phase A | Mg)Al₂O₄ | Mg)Al₂O₄ | Mg)Al₂O₄ | Mg)Al₂O₄ | Mg)Al₂O₄ |
| | Crystal | ZrO₂ | ZrO₂ | ZrO₂ | ZrO₂ | ZrO₂ |
| | Phase B | | | | | |
| | Crystal | / | / | / | / | / |
| | Phase C | | | | | |

| | | | | | |
|---|---|---|---|---|---|
| Crystallinity/w t% | 34.8% | 36.1% | 35.6% | 34.2% | 36.2% |
| Average Grain | 5.6 | 5.7 | 5.8 | 5.9 | 5.8 |
| Size/nm | | | | | |
| State after Heat | Transparent | Transparent | Transparent | Transparent | Transparent |
| Treatment | | | | | |

As shown above, due to the excessive high content of Li₂O in D2, quartz solid solution (MgAl₂Si₃O₁₀) is easily generated during the heat treatment process, which leads to fogging and even ceramization of glass. The ceramization here refers to the uncontrollable growth of quartz crystals in microcrystalline glass during heat treatment, which causes the sample to lose the transparent property of glass and turn into a white color similar to ceramics, as shown in FIG. 6. Only the crystal phase of ZrO₂ is precipitated during the heat treatment in D3 under the condition of R₂ without the desired zinc-magnesium-spinel solid solution. At a relatively high temperature of 850° C.-4 h (R₃, conducting the crystallization treatment at 850° C.), the crystallinity is only 17.6 wt %. Even with the nucleation treatment (R₈, conducting the crystallization treatment at 850° C. and conducting the nucleation treatment before crystallization treatment), the crystallinity is only 18.3 wt %; only when the heat treatment is carried out at high temperature (R₄, conducting the crystallization treatment at 900° C.), a sample with a good crystallization state can be obtained, and the crystallinity reaches 35.7 wt %. The sample turns brown after heat treatment because D4 contains TiO₂ part. The sample is fogged after heat treatment due to the excessive low content of ZrO₂ in D6. However, the specific reason cannot be identified from XRD parameters, it is speculated from the literature that it can be fogged due to the aggregation of small grains. The transparent microcrystalline glass is obtained by D7. The sample is fogged after heat treatment due to the excessive high content of B₂O₃ in D9, which can be caused by phase separation, and the difference cannot be identified from XRD parameters. The quartz solid solution (MgAl₂Si₃O₁₀) appears after crystallization due to the low content of Al₂O₃ in D10, and the sample is fogged, as shown in FIG. 8.

TABLE 5A
Physical Parameters and Strengthening Parameters (I)

| Experiment No. | | 8 | 12 | 15 | 17 | 19 | 20 | 21 | 22 | 23 | 24 |
|---|---|---|---|---|---|---|---|---|---|---|---|
| Glass formulation and | | D3, | D4, | D7, | D9, | S1, | S2, | S3, | S4, | S5, | S6, |
| No. of heat treatment | | R₄ | R₁₀ | R₆ | R₆ | R₆ | R₆ | R₇ | R₆ | R₆ | R₆ |
| process | | | | | | | | | | | |
| Optical | a* (D65) | −0.08 | 0.49 | −0.11 | 0.1 | −0.05 | −0.03 | −0.08 | −0.04 | −0.08 | −0.1 |
| property | b* (D65) | 0.75 | 2.52 | 0.65 | 3.56 | 0.65 | 0.64 | 0.68 | 0.86 | 0.75 | 0.69 |
| | Transmittance | 71.46 | 68.59 | 72.3 | 43.6 | 75.8 | 75.9 | 73.56 | 71.23 | 72.56 | 73.41 |
| | at 360 nm/% | | | | | | | | | | |
| | Transmittance | 89.69 | 86.96 | 89.6 | 75.4 | 90.02 | 90.05 | 89.86 | 89.31 | 89.54 | 89.79 |
| | at 550 nm/% | | | | | | | | | | |
| | Refractive | 1.57 | 1.56 | 1.58 | 1.59 | 1.59 | 1.60 | 1.59 | 1.59 | 1.60 | 1.59 |
| | index | | | | | | | | | | |
| Physical | Young's | 110.8 | 113.5 | 121.4 | 120.8 | 123.6 | 121.6 | 120.45 | 121.5 | 122.6 | 123.5 |
| parameter | modulus/GPa | | | | | | | | | | |
| Strength- | Strengthening | 100 | 100 | 100 | 100 | 100 | 50 | 100 | 100 | 100 | 100 |
| ening | salt bath | wt % | wt % | wt % | wt % | wt % | wt % | wt % | wt % | wt % | wt % |
| process | | NaNO₃ | NaNO₃ | NaNO₃ | NaNO₃ | NaNO₃ | NaNO₃ + | NaNO₃ | NaNO₃ | NaNO₃ | NaNO₃ |
| | | | | | | | 50 | | | | |
| | | | | | | | wt % | | | | |
| | | | | | | | KNO₃ | | | | |
| | Strengthening | 450° | 450° | 450° | 450° | 450° | 450° | 450° | 450° | 450° | 450° |
| | condition | C.-5 h | C.-5 h | C.-5 h | C.-5 h | C.-5 h | C.-5 h | C.-5 h | C.-5 h | C.-5 h | C.-5 h |
| | (temperature + | | | | | | | | | | |
| | duration) | | | | | | | | | | |
| | \|CT_AV\|/Mpa | 34.3 | 32.6 | 22.6 | 45.4 | 68.7 | 58.1 | 45.6 | 57.2 | 47.8 | 46.9 |
| | DOL_0/μm | 82.3 | 85.3 | 90.5 | 121.8 | 131.6 | 129.5 | 118.6 | 124.6 | 120.5 | 126.9 |
| | Strengthened | 824 | 821 | 837 | 826 | 836 | 819 | 817 | 824 | 835 | 834 |
| | Vickers | | | | | | | | | | |
| | hardness | | | | | | | | | | |
| | (kgf/mm²) | | | | | | | | | | |
| | Fracture | 1.602 | 1.601 | 1.615 | 1.604 | 1.617 | 1.597 | 1.593 | 1.603 | 1.611 | 1.612 |
| | toughness/ | | | | | | | | | | |
| | Mpa · m^{1/2} | | | | | | | | | | |
| Drop | Average drop | 0.62 | 0.62 | / | / | 1.45 | / | / | / | / | / |
| testing | height tested | | | | | | | | | | |
| | by using 80- | | | | | | | | | | |
| | mesh abrasive | | | | | | | | | | |
| | paper/m | | | | | | | | | | |

TABLE 5B
Physical Parameters and Strengthening Parameters (II)

| Experiment No. | | 25 | 26 | 27 | 28 | 29 | 30 |
|---|---|---|---|---|---|---|---|
| Glass formulation and | | S7, | S8, | S9, | S10, | S11, | S12, |
| No. of heat treatment | | R₆ | R₇ | R₆ | R₆ | R₇ | R₇ |
| process | | | | | | | |
| Optical | a* (D65) | −0.09 | −0.12 | −0.11 | −0.07 | −0.03 | −0.08 |
| property | b* (D65) | 0.82 | 0.81 | 0.76 | 0.82 | 0.72 | 0.69 |
| | Transmittance | 71.56 | 71.28 | 72.41 | 71.53 | 72.41 | 73.56 |
| | at 360 nm/% | | | | | | |
| | Transmittance | 89.42 | 89.56 | 89.52 | 89.49 | 89.34 | 89.96 |
| | at 550 nm/% | | | | | | |
| | Refractive | 1.61 | 1.59 | 1.59 | 1.59 | 1.59 | 1.59 |
| | index | | | | | | |
| Physical | Young's | 124.6 | 120.3 | 121.5 | 119.8 | 123.8 | 121.8 |
| parameter | modulus/GPa | | | | | | |
| Strength- | Strengthening | 100 | 70 | 100 | 100 | 30 | 100 |
| ening | salt bath | wt % | wt % | wt % | wt % | wt % | wt % |
| process | | NaNO₃ | NaNO₃ + | NaNO₃ | NaNO₃ | NaNO₃ + | NaNO₃ |
| | | | 30 | | | 70 | |
| | | | wt % | | | wt % | |
| | | | KNO₃ | | | KNO₃ | |
| | Strengthening | 450° C.-5 h | 450° C.-5 h | 450° C.-5 h | 450° C.-5 h | 450° C.-5 h | 450° C.-5 h |
| | condition | | | | | | |
| | (temperature + | | | | | | |
| | duration) | | | | | | |
| | \|CT_AV\|/Mpa | 48.9 | 43.8 | 41.8 | 56.8 | 57.3 | 41.6 |
| | DOL_0/μm | 136.9 | 120.6 | 119.8 | 130.5 | 131.5 | 105.6 |
| | Strengthened | 857 | 824 | 815 | 826 | 847 | 825 |
| | Vickers | | | | | | |
| | hardness | | | | | | |
| | (kgf/mm²) | | | | | | |
| | Fracture | 1.623 | 1.601 | 1.594 | 1.605 | 1.621 | 1.601 |
| | toughness/ | | | | | | |
| | Mpa · m^{1/2} | | | | | | |
| Drop | Average drop | 1.24 | / | / | / | / | / |
| testing | height tested | | | | | | |
| | by using 80- | | | | | | |
| | mesh abrasive | | | | | | |
| | paper/m | | | | | | |

TABLE 5C
Physical Parameters and Strengthening Parameters (III)

| Experiment No. | | 31 | 32 | 33 | 34 | 35 |
|---|---|---|---|---|---|---|
| Glass formulation and No. | | S13, R₆ | S14, R₇ | S15, R₇ | S16, R₆ | S17, R₇ |
| of heat treatment process | | | | | | |
| Optical property | a* (D65) | −0.05 | −0.06 | −0.09 | −0.05 | −0.12 |
| | b* (D65) | 0.71 | 0.85 | 0.62 | 0.85 | 0.71 |
| | Transmittance at | 72.48 | 71.22 | 75.65 | 70.59 | 72.45 |
| | 360 nm/% | | | | | |
| | Transmittance at | 89.34 | 89.12 | 90.12 | 89.55 | 89.35 |
| | 550 nm/% | | | | | |
| | Refractive index | 1.60 | 1.58 | 1.59 | 1.58 | 1.59 |
| Physical parameter | Young's modulus/GPa | 124.5 | 119.4 | 121.3 | 118.7 | 122.6 |
| Strengthening | Strengthening salt bath | NaNO₃ | NaNO₃ | NaNO₃ | NaNO₃ | NaNO₃ |
| process | Strengthening condition | 450° C.-5 h | 450° C.-5 h | 450° C.- 5h | 450° C.-5 h | 450° C.-5 h |
| | (temperature + duration) | | | | | |
| | \|CT_AV\|/Mpa | 40.6 | 42.5 | 54.8 | 68.9 | 45.6 |
| | DOL_0/μm | 119.3 | 117.6 | 125.6 | 135.6 | 128.3 |
| | Strengthened Vickers | 836 | 845 | 834 | 849 | 824 |
| | hardness (kgf/mm²) | | | | | |
| | Fracture | 1.612 | 1.619 | 1.61 | 1.619 | 1.602 |
| | toughness/Mpa · m^{1/2} | | | | | |
| Drop testing | Average drop height | 1.18 | / | / | 1.47 | / |
| | tested by using 80- | | | | | |
| | mesh abrasive paper/m | | | | | |

As shown above, in Experiment No. 8, due to the low content of Al₂O₃ in the base glass, the microcrystalline glass only obtains poor stress after chemical strengthening treatment. In Experiment No. 12, because the base glass contains TiO₂, the a*(D65) and b*(D65) values of microcrystalline glass are both high, and the optical properties are poor. In Experiment No. 15, due to the low content of Li₂O in the base glass, the deep stress obtained by strengthening the microcrystalline glass is in a low level, and the depth of the compressive stress layer is less than 95 μm. In Experiment No. 17, due to the extremely high content of B₂O₃ in the base glass, the phase separation occurs during the heat treatment, so that the transmittance of the microcrystalline glass is poor. In experiment No. 19~35, after chemical strengthening, the microcrystalline glass all have excellent optical properties and deep stress level, so that the drop resistance is good. Tested with 80-mesh abrasive paper, the average anti-abrasive-paper drop height is all above 1.0 m.

1. A microcrystalline glass, wherein the microcrystalline glass contains a (Zn, Mg) Al₂O₄ as a principal crystalline phase and a tetragonal ZrO₂ as a secondary crystalline phase; and the microcrystalline glass contains following proportions of oxide components in terms of a molar percentage of oxides:

| component | mol % |
|---|---|
| SiO₂ | 38.00%~50.00% |
| Al₂O₃ | 25.00%~30.00% |
| MgO | 4.00%~8.00% |
| ZnO | 8.00%~14.00% |
| ZrO₂ | 3.00%~5.00% |
| Li₂O | 3.00%~8.00% |
| | (excluding 8.00 mol %); |

and
the microcrystalline glass basically does not contain TiO₂, wherein
a content of the oxide components of the microcrystalline glass satisfies following relational expressions:
$${Al}_{2} {O}_{3} / ( MgO + Z n O ) = 1.4 ∼ 2. ; \qquad ( 1 )$$
$$( {K}_{2} O + L {i}_{2} O + N {a}_{2} O + {B}_{2} {O}_{3} ) / ( Si {O}_{2} + {Al}_{2} {O}_{3} ) = 0.1 ∼ 0.2 ; \qquad ( 2 )$$
and
in the relational expressions, each oxide represents a mole percentage content of an oxide in the component.

2. The microcrystalline glass according to claim 1, wherein a mole percentage of SiO₂ in the microcrystalline glass is 38.50%~48.50%; and/or a mole percentage of Al₂O₃ is 25.00%~29.00%; and/or a mole percentage of MgO is 4.50%~7.50%; and/or a mole percentage of ZnO is 8.50%~13.50%; and/or a mole percentage of ZrO₂ is 3.00%~4.50%; and/or a mole percentage of Li₂O is 3.00%~7.80%.

3. The microcrystalline glass according to claim 1, wherein the microcrystalline glass further contains oxide components in following proportions in terms of a mole percentage of oxides:

| | |
|---|---|
| Na₂O | 0%~6.00% |
| K₂O | 0%~3.00% |
| B₂O₃ | 0%~6.00% |
| BaO | 0%~4.00% |
| Y₂O₃ | 0%~2.00% |
| La₂O₃ | 0%~2.00%. |

4. The microcrystalline glass according to claim 1, wherein the content of the oxide components, in terms of a mol %, satisfies at least one of relational expressions (3), (4) and (5):
$${Al}_{2} {O}_{3} / Si {O}_{2} = 0.5 ∼ 0.8 ; \qquad ( 3 )$$
$$L {i}_{2} O / ( {K}_{2} O + L {i}_{2} O + N {a}_{2} O ) = 0 \text{.25} ∼ 0.85 ; and \qquad ( 4 )$$
$$L {i}_{2} O + N {a}_{2} O \geq 7. mol \% . \qquad ( 5 )$$

5. (canceled)

6. The microcrystalline glass according to claim 1, wherein a weight ratio of a crystal phase of the microcrystalline glass to the microcrystalline glass is 25.0 wt %~45.0 wt %; and/or
an average grain size of the microcrystalline glass is 3.0 nm~30.0 nm; and/or
a Young's modulus of the microcrystalline glass is ≥110 GPa.

7. The microcrystalline glass according to claim 1, wherein a weight ratio of a crystal phase of the microcrystalline glass to the microcrystalline glass is 30.0~45.0 wt %; and/or
an average grain size of the microcrystalline glass is 3.0 nm~10.0 nm; and/or
a Young's modulus of the microcrystalline glass meets 130 GPa≥Young's modulus ≥114 GPa.

8. (canceled)

9. The microcrystalline glass according to claim 1, wherein when a thickness is 0.7 mm, the microcrystalline glass has a following transmission color coordinate in a CIELAB color space:
a*=−0.15~0.15, preferably −0.15 to −0.03; and
b*=0.30~0.90, preferably 0.60 to 0.85, which is for a D65 light source in a SCI mode; and/or
when a thickness is 0.7 mm and under a light with a wavelength of 550 nm, the microcrystalline glass has a transmittance above 85.0%;
when the thickness is 0.7 mm and under a light with a wavelength of 360 nm, a transmittance of the microcrystalline glass is above 70.0%.

10.-25. (canceled)

26. The microcrystalline glass according to claim 3, wherein the contents of the oxide components are expressed in mol %, and in the microcrystalline glass, SiO₂ has a mole percentage of 40.00%~48.50%, and/or Al₂O₃ has a mole percentage of 25.00%~27.50%, and/or MgO has a mole percentage of 4.50%~6.00%, and/or ZnO has a mole percentage of 9.00%~11.00%, and/or ZrO₂ has a mole percentage of 3.00%~4.00%, and/or Li₂O has a mole percentage of 3.50%~7.00%, and/or Na₂O has a mole percentage of 2.5%~4.0%, and/or K₂O has a mole percentage of 0%~1.00%, and/or B₂O₃ has a mole percentage of 0%~2.0%, and/or BaO has a mole percentage of 0.5%~2.5%, and/or Y₂O₃ has a mole percentage of 0%~1.0%, and/or La₂O₃ has a mole percentage of 0%~1.0%.

27. A chemically strengthened microcrystalline glass, wherein the chemically strengthened microcrystalline glass comprises a compressive stress layer and a tensile stress layer; the chemically strengthened microcrystalline glass contains a (Zn, Mg) Al₂O₄ as a principal crystalline phase and a tetragonal ZrO₂ as a secondary crystalline phase; and
in terms of a molar percentage of oxides, components of the tensile stress layer of the chemically strengthened microcrystalline glass contain:

| component | mol % |
|---|---|
| SiO₂ | 38.00%~50.00% |
| Al₂O₃ | 25.00%~30.00% |
| MgO | 4.00%~8.00% |
| ZnO | 8.00%~14.00% |
| ZrO₂ | 3.00%~5.00% |
| Li₂O | 3.00%~8.00%; |

and
the chemically strengthened microcrystalline glass basically does not contain TiO₂, and the molar percentage of Li₂O is not 8.00 mol %, wherein
in terms of a molar percentage of oxides, the components of the tensile stress layer of the chemically strengthened microcrystalline glass satisfy following relational expressions:
$${Al}_{2} {O}_{3} / ( MgO + Z n O ) = 1.4 ∼ 2. ; \qquad ( 1 )$$
$$( {K}_{2} O + L {i}_{2} O + N {a}_{2} O + {B}_{2} {O}_{3} ) / ( Si {O}_{2} + {Al}_{2} {O}_{3} ) = 0.1 ∼ 0.2 ; \qquad ( 2 )$$
and
in the relational expressions, each oxide represents a mole percentage content of an oxide in the components.

28. The chemically strengthened microcrystalline glass according to claim 27, wherein in terms of a molar percentage of oxides, in the tensile stress layer of the chemically strengthened microcrystalline glass, a mole percentage of SiO₂ is 38.50%~48.50%; and/or a mole percentage of Al₂O₃ is 25.00%~29.00%; and/or a mole percentage of MgO is 4.50%~7.50%; and/or a mole percentage of ZnO is 8.50%~13.50%; and/or a mole percentage of ZrO₂ is 3.00%~4.50%; and/or a mole percentage of Li₂O is 3.00%~7.80%.

29. The chemically strengthened microcrystalline glass according to claim 27, wherein in terms of a mole percentage of oxides, the components of the tensile stress layer of the chemically strengthened microcrystalline glass further contain:

| | |
|---|---|
| Na₂O | 0%~6.00% |
| K₂O | 0%~3.00% |
| B₂O₃ | 0%~6.00% |
| BaO | 0%~4.00% |
| Y₂O₃ | 0%~2.00% |
| La₂O₃ | 0%~2.00%. |

30. The chemically strengthened microcrystalline glass according to claim 27, wherein in terms of a mol % of the contents of the oxide components, the components of the tensile stress layer of the chemically strengthened microcrystalline glass satisfy at least one of relational expressions (3), (4) and (5):
$${Al}_{2} {O}_{3} / Si {O}_{2} = 0.5 ∼ 0.8 ; \qquad ( 3 )$$
$$L {i}_{2} O / ( {K}_{2} O + L {i}_{2} O + N {a}_{2} O ) = 0 \text{.25} ∼ 0.85 ; and \qquad ( 4 )$$
$$L {i}_{2} O + N {a}_{2} O \geq 7. mol \% . \qquad ( 5 )$$

31. The chemically strengthened microcrystalline glass according to claim 29, wherein in terms of a mole percentage of oxides, in the tensile stress layer of the chemically strengthened microcrystalline glass, SiO₂ has a mole percentage of 40.00%~48.50%, and/or Al₂O₃ has a mole percentage of 25.00%~27.50%, and/or MgO has a mole percentage of 4.50%~6.00%, and/or ZnO has a mole percentage of 9.00%~11.00%, and/or ZrO₂ has a mole percentage of 3.00%~4.00%, and/or Li₂O has a mole percentage of 3.50%~7.00%, and/or Na₂O has a mole percentage of 2.5%~4.0%, and/or K₂O has a mole percentage of 0%~1.00%, and/or B₂O₃ has a mole percentage of 0%~2.0%, and/or BaO has a mole percentage of 0.5%~2.5%, and/or Y₂O₃ has a mole percentage of 0%~1.0%, and/or La₂O₃ has a mole percentage of 0%~1.0%.

32. The chemically strengthened microcrystalline glass according to claim 27, wherein a weight ratio of a crystal phase of the chemically strengthened microcrystalline glass to the chemically strengthened microcrystalline glass is 25.0 wt %~45.0 wt %, and/or an average grain size of the chemically strengthened microcrystalline glass is 3.0 nm~30.0 nm; and/or a Young's modulus of the chemically strengthened microcrystalline glass is ≥110 GPa.

33. The chemically strengthened microcrystalline glass according to claim 32, wherein a weight ratio of a crystal phase of the chemically strengthened microcrystalline glass to the chemically strengthened microcrystalline glass is 30.0 wt %~45.0 wt %; and/or an average grain size of the chemically strengthened microcrystalline glass is 3.0 nm~10.0 nm; and/or a Young's modulus of the chemically strengthened microcrystalline glass meets 130 GPa≥Young's modulus ≥114 GPa.

34. The chemically strengthened microcrystalline glass according to claim 27, wherein the chemically strengthened microcrystalline glass comprises the compressive stress layer having a depth DOL_0≥0.14t, where t is a thickness of the chemically strengthened microcrystalline glass, and/or
the chemically strengthened microcrystalline glass has a |CT_AV| of ≥40.0 MP.

35. The chemically strengthened microcrystalline glass according to claim 34, wherein the chemically strengthened microcrystalline glass comprises the compressive stress layer having a depth DOL_0 meeting 0.20t≥DOL_0≥0.15t, and/or
the chemically strengthened microcrystalline glass has a |CT_AV| meeting 80.0 MPa≥|CT_AV|≥40.0 MPa.

36. The chemically strengthened microcrystalline glass according to claim 27, wherein a Vickers hardness of the chemically strengthened microcrystalline glass is above 750 kgf/mm², and/or a fracture toughness of the chemically strengthened microcrystalline glass is above 1.200 MPa·m^{1/2}.

37. The chemically strengthened microcrystalline glass according to claim 27,
wherein when a thickness is 0.7 mm and under a light with a wavelength of 550 nm, the chemically strengthened microcrystalline glass has a transmittance above 85.0%; and/or when the thickness is 0.7 mm and under a light with a wavelength of 360 mn, a transmittance of the chemically strengthened microcrystalline glass is above 70.0%; and/or
at a thickness of 0.7 mm, the chemically strengthened microcrystalline glass is performed on an anti-abrasive-paper drop testing by using an 80-mesh abrasive paper, and an average anti-abrasive-paper drop height of the chemically strengthened microcrystalline glass is greater than or equal to 0.8 m.

38. An electronic terminal, wherein the electronic terminal comprises the microcrystalline glass according to claim 1.
